(19) United States
(12) Patent Application Publication
(10) Pub. No.: US 2026/0255086 A1
(43) Pub. Date: Aug. 27, 2026

(54) IMAGE SENSOR AND OPERATING METHOD THEREOF

(71) Applicant: Samsung Electronics Co., Ltd., Suwon-si (KR)

(72) Inventors: Dahsom Kim, Suwon-si (KR); Jahyun Koo, Suwon-si (KR); Donghoon Sung, Suwon-si (KR); Seokyong Hong, Suwon-si (KR)

(21) Appl. No.: 19/335,551

(22) Filed: Sep. 22, 2025

(30) Foreign Application Priority Data
Feb. 27, 2025 (KR) 10-2025-0025672

(51) Int. Cl. H04N 25/78; H04N 25/57; H04N 25/709

(52) U.S. Cl. CPC H04N 25/78; H04N 25/57; H04N 25/709

(57) ABSTRACT

An image sensor includes a pixel array including pixels arranged in first and directions, samplers connected to the pixels through column lines extending in the first direction, and a ramp generator including first and second ramp generators output first and second ramp voltages. The column lines include first and second column lines adjacent to each other in the second direction. The samplers include first and second samplers disposed adjacently in the first direction. In a first mode, the first and second samplers are electrically connected to the first ramp generator and electrically separated from the second ramp generator. In a second mode, the first sampler is electrically connected to the first ramp generator among the first ramp generator and the second ramp generator, and the second sampler is electrically connected to the second ramp generator among the first ramp generator and the second ramp generator.

### CROSS-REFERENCE TO RELATED APPLICATION(S)

This application claims benefit of priority to Korean Patent Application No. 10-2025-0025672 filed on Feb. 27, 2025 in the Korean Intellectual Property Office, the disclosure of which is incorporated herein by reference in its entirety.

### BACKGROUND

Example embodiments of the present disclosure relate to an image sensor and an operating method thereof.

An image sensor may receive light and may generate an electrical signal, and may include a pixel array having a plurality of pixels, and a peripheral circuit for driving the pixel array and generating an image. Each of pixels may include a photodiode, a pixel circuit for converting electric charge generated by the photodiode into an electrical signal, and the peripheral circuit may include a row driver connected to the pixels by a plurality of row lines, a readout circuit connected to the pixels by a plurality of column lines, and a ramp generator for providing a ramp voltage to the readout circuit. As an image sensor are increasingly employed in an electronic device operating on batteries, various methods for effectively managing power consumed by an image sensor has been suggested.

### SUMMARY

An example embodiment of the present disclosure is to provide an image sensor which may effectively manage power consumption by configuring connection between ramp generators configured to output different ramp voltages and a plurality of samplers included in a readout circuit differently depending on an operation mode, and an operating method thereof.

According to an aspect of the present disclosure, an image sensor includes a pixel array including a plurality of pixels arranged in a first direction and a second direction intersecting the first direction, a plurality of samplers connected to the plurality of pixels through a plurality of column lines extending in the first direction, and a ramp generator including a first ramp generator configured to output a first ramp voltage, and a second ramp generator configured to output a second ramp voltage different from the first ramp voltage. The plurality of column lines include a first column line and a second column line adjacent to each other in the second direction. The plurality of samplers include a first sampler and a second sampler disposed adjacently to each other in the first direction. In a first mode, the first sampler and the second sampler are electrically connected to the first ramp generator and electrically separated from the second ramp generator. In a second mode different from the first mode, the first sampler is electrically connected to the first ramp generator among the first ramp generator and the second ramp generator, and the second sampler is electrically connected to the second ramp generator among the first ramp generator and the second ramp generator.

According to an aspect of the present disclosure, an image sensor includes a pixel array including a plurality of pixels including a first pixel and a second pixel, the first pixel connected to a first column line and the second pixel connected to a second column line, a ramp generator configured to output a ramp voltage, and a readout circuit including a first sampler and a second sampler. Each of the first sampler and the second sampler includes an amplifier configured to compare the ramp voltage with at least one of a voltage output by the first pixel and a voltage output by the second pixel, a ramp buffer configured to receive the ramp voltage from the ramp generator and to transfer the ramp voltage to the amplifier, and a switch circuit connecting the amplifier to the ramp buffer. The switch circuit of the first sampler includes a first switch connecting the ramp buffer of the first sampler to the amplifier of the first sampler, and a second switch connecting the ramp buffer of the first sampler to the amplifier of the second sampler.

According to an aspect of the present disclosure, an operating method of an image sensor includes driving an image sensor in a first mode, determining whether a second mode different from the first mode is selected, connecting a plurality of column lines connected to a plurality of pixels included in the image sensor to a plurality of samplers, and inputting a first ramp voltage to the plurality of samplers, when the second mode is not selected and the first mode is maintained, and connecting each of the plurality of column lines to two or more samplers among the plurality of samplers, inputting the first ramp voltage to one sampler of the two or more samplers, and inputting a second ramp voltage different from the first ramp voltage to another sampler of the two or more samplers, when the second mode is selected instead of the first mode.

### BRIEF DESCRIPTION OF DRAWINGS

The above and other aspects, features, and advantages of the present disclosure will be more clearly understood from the following detailed description, taken in combination with the accompanying drawings, in which:

FIG. 1 is a block diagram illustrating an image sensor according to an example embodiment of the present disclosure;

FIG. 2 is a diagram illustrating a pixel array of an image sensor according to an example embodiment of the present disclosure;

FIG. 3 is a circuit diagram illustrating pixels included in an image sensor according to an example embodiment of the present disclosure;

FIGS. 4 and 5 are diagram illustrating a structure of an image sensor according to an example embodiment of the present disclosure;

FIGS. 6A and 6B are diagrams illustrating an operation of an image sensor according to an example embodiment of the present disclosure;

FIG. 7 is a flowchart illustrating operations of an image sensor according to an example embodiment of the present disclosure;

FIGS. 8, 9, 10, 11A, 11B, and 12 are diagrams illustrating operations of an image sensor according to an example embodiment of the present disclosure;

FIGS. 13 and 14 are diagrams illustrating operations of an image sensor according to an example embodiment of the present disclosure;

FIGS. 15, 16, 17, 18A, 18B, and 19 are diagrams illustrating operations of an image sensor according to an example embodiment of the present disclosure;

FIGS. 20, 21, 22A, 22B, 23, and 24 are diagrams illustrating operations of an image sensor according to an example embodiment of the present disclosure;

FIGS. 25 and 26 are diagrams illustrating a structure of an image sensor according to an example embodiment of the present disclosure;

FIG. 27 is a diagram illustrating a structure of an image sensor according to an example embodiment of the present disclosure; and

FIG. 28 is a diagram illustrating operations of an image sensor according to an example embodiment of the present disclosure.

### DETAILED DESCRIPTION

Hereinafter, embodiments of the present disclosure will be described as below with reference to the accompanying drawings.

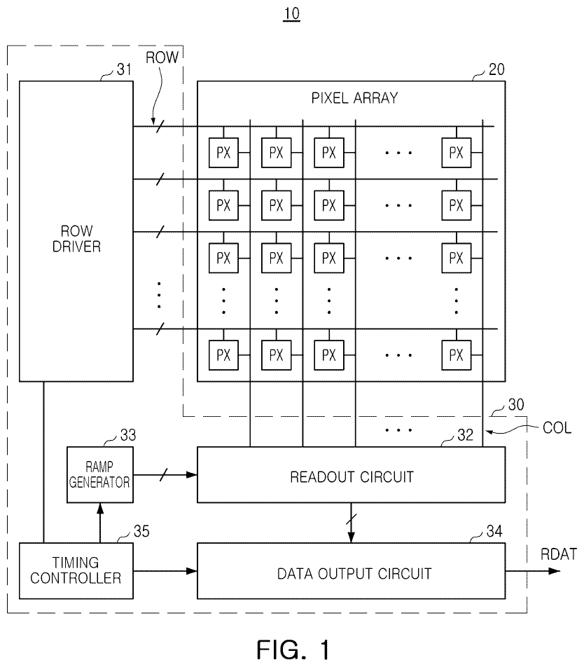

FIG. 1 is a block diagram illustrating an image sensor according to an example embodiment.

Referring to FIG. 1, an image sensor 10 may include a pixel array 20 and a peripheral circuit 30.

The pixel array 20 may include a plurality of pixels PX disposed in an array form along a plurality of rows and a plurality of columns. Each of the plurality of pixels PX may include a photoelectric conversion element configured to generate electric charge in response to light, and the photoelectric conversion element may be connected to a pixel circuit configured to generate and output a signal corresponding to electric charge. The pixel PX may be implemented by the photoelectric conversion element and the pixel circuit, and in example embodiments, two or more pixels PX disposed adjacently to each other may share the pixel circuit. The photoelectric conversion element may include a photodiode formed of a semiconductor material, and/or an organic photodiode formed of an organic material. The pixel circuit may include a plurality of transistors controlled by the peripheral circuit 30.

The peripheral circuit 30 may include circuits for controlling the pixel array 20. For example, the peripheral circuit 30 may include a row driver 31, a readout circuit 32, a ramp generator 33 (i.e., a ramp generator circuit), a data output circuit 34, and a timing controller 35. The row driver 31 may drive the pixel array 20 in unit of row lines ROW. For example, the row driver 31 may input control signals for controlling turning on/off of each transistor included in the pixel circuit to the pixel array 20 in unit of row lines ROW.

Among the pixels COL, pixels COL disposed in the same position in the row direction (horizontal direction in FIG. 1) may share the same column line. For example, at least a portion of the pixels PX disposed in the same position in the column direction (vertical direction in FIG. 1) may be simultaneously selected by the row driver 31, and the selected pixels PX may output a pixel signal through the column lines COL.

In an example embodiment, the readout circuit 32 may read a signal from pixels PX selected by the row driver 31 through the column lines COL. For example, the readout circuit 32 may read a reset voltage and a signal voltage in sequence from each of the pixels PX, and the signal voltage may be obtained by reflecting electric charge generated by a photodiode of each pixel in the reset voltage. The reset voltage output is a voltage obtained from the pixel read immediately after reset and before exposure to light. The signal voltage is a voltage obtained from the pixel read after exposure. The difference between the signal voltage and the reset voltage constitutes a pixel signal with noise removed.

The readout circuit 32 may include a plurality of samplers (i.e., sampler circuits), and the plurality of samplers may be connected to a plurality of counters. The plurality of samplers may be connected to the pixels PX through the column lines COL, and for example, a select circuit configuring a connection between the column lines COL and the plurality of samplers may be included in the readout circuit 32.

An input terminal of each of the plurality of samplers may be electrically connected to the column line COL, and may receive the reset voltage and the signal voltage output by the pixel circuit, and the other input terminal may receive a ramp voltage from the ramp generator 33. The output terminal of the sampler may be connected to a counter, and the counter may generate a digital signal by counting the time period during which an output of the sampler is maintained at a predetermined voltage using a specific clock signal.

For example, while the reset voltage and the ramp voltage are input to the sampler, the counter may count the time period during which the reset voltage is greater than the ramp voltage. Similarly, while the signal voltage and the ramp voltage are input to the sampler, the counter may count the time period during which the signal voltage is greater than the ramp voltage. For example, a digital pixel signal corresponding to a difference between results of the counter, obtained by counting each time period, may be generated, and the digital pixel signal may be output to an external entity as a row data RDAT by the data output circuit 34.

The data output circuit 34 may include a memory such as a latch or a buffer circuit temporarily storing the digital pixel signal, and the digital pixel signal may be output to an image signal processor. The timing controller 35 may control the operation timings of the row driver 31, the readout circuit 32, the ramp generator 33, and the data output circuit 34.

In an example embodiment, the ramp generator 33 may provide a first ramp voltage and a second ramp voltage having different properties to the readout circuit 32. For example, the first ramp voltage and the second ramp voltage may have different slopes (i.e., temporal slopes).

The readout circuit 32 may implement various functions using the first ramp voltage and the second ramp voltage. For example, the readout circuit 32 may compare the first ramp voltage and the second ramp voltage having different slopes with the reset voltage output by each of the pixels PX and compare the first ramp voltage and the second ramp voltage having different slopes with the signal voltage output by each of the pixels PX. Accordingly, by applying different analog gains to the reset voltage and the signal voltage output by each of the pixels PX, a digital pixel signal may be generated, and a high-quality image may be generated by increasing a dynamic range of the image sensor 10.

Depending on an operation mode of the image sensor 10, the readout circuit 32 may operate using only one of the first ramp voltage and the second ramp voltage. For example, the readout circuit 32 may compare the reset voltage and the signal voltage output by each pixel PX with the first ramp voltage or the second ramp voltage. By selectively using the first ramp voltage and the second ramp voltage depending on the operation mode of the image sensor 10 as described above, quality of an image generated by the image sensor 10 may be improved and power consumption of the image sensor 10 may be efficiently managed.

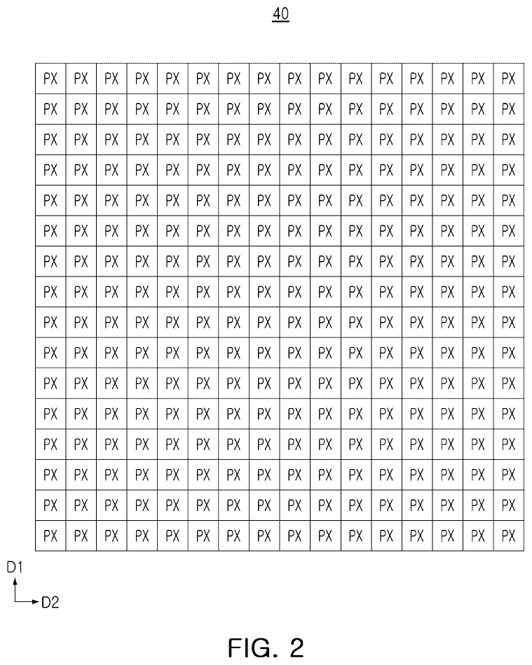

FIG. 2 is a diagram illustrating a pixel array of an image sensor according to an example embodiment.

Referring to FIG. 2, a pixel array 40 according to an example embodiment may include a plurality of pixels PX arranged in a first direction D1 and a second direction D2. Each of the plurality of pixels PX may include at least one photodiode. In example embodiments, a pixel circuit converting an electric charge generated by the photodiode into a voltage and outputting the charge may be provided in each of the plurality of pixels PX. Alternatively, two or more adjacent pixels PX in at least one of the first direction D1 and the second direction D2 may share one pixel circuit.

The first direction D1 may be defined as a column direction, and the second direction D2 may be defined as a row direction. The pixels PX disposed in the same position in the second direction D2 and arranged in the first direction D1 may be commonly connected to one column line. The pixels PX disposed in the same position in the first direction D1 and arranged in the second direction D2 may be commonly connected to two or more row lines.

As described above with reference to FIG. 1, a plurality of row lines extending in the row direction may be connected to a row driver, and a plurality of column lines extending in the column direction may be connected to a readout circuit. The readout circuit may include a plurality of samplers, and the plurality of samplers may include a ramp buffer configured to buffer a ramp voltage, and an amplifier configured to compare the ramp voltage with a voltage of one of the plurality of column lines.

In an example embodiment, a plurality of samplers may be disposed in the same position in the first direction D1 and arranged in the second direction D2. In this case, one sampler and pixels PX sharing one column line may be arranged in the first direction D1. However, as the number of pixels PX disposed in the pixel array 40 increases and an area of each pixel PX decreases to increase resolution supported by the image sensor, a portion of the samplers may be disposed in a different position in the first direction D1. For example, the samplers of a first group and the samplers of a second group may be disposed in different positions in the first direction D1.

In an example embodiment, a ramp generator supplying a ramp voltage to a plurality of samplers may output a first ramp voltage and a second ramp voltage. The first ramp voltage and the second ramp voltage may have the same properties or different properties depending on an operation mode of the image sensor including the pixel array 40.

The ramp generator may include a first ramp generator configured to output the first ramp voltage and a second ramp generator configured to output the second ramp voltage. In an example embodiment, depending on an operation mode of the image sensor, only one of the first ramp generator and the second ramp generator may be activated and the other may be deactivated, and accordingly, power consumption of the image sensor may be efficiently managed. Also, by activating the first ramp generator and the second ramp generator such that the first ramp voltage and the second ramp voltage having different properties may be output, the dynamic range of the image sensor may be widened and a high-quality image may be output.

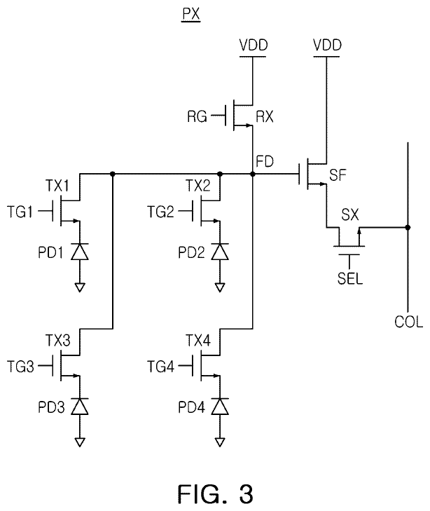

FIG. 3 is a circuit diagram illustrating pixels included in an image sensor according to an example embodiment.

Referring to FIG. 3, in an example embodiment, a pixel PX may be implemented such that two or more photodiodes PD1-PD4 may share one pixel circuit. The pixel circuit may include a floating diffusion node FD, a reset transistor RX, an amplifier transistor SF, and a select transistor SX. The photodiodes PD1-PD4 may be commonly connected to one floating diffusion node FD through transfer transistors TX1 to TX4. Control signals TG1 to TG4, RG, and SEL controlling a plurality of transistors TX1 to TX4, RX, SF, and SX may be output by a row driver included in a peripheral circuit.

When at least one of the transfer transistors TX1 to TX4 is turned on by the transfer control signals TG1 to TG4, an electric charge of at least one of the photodiodes PD1-PD4 may be stored in the floating diffusion node FD. In this case, when the reset transistor RX is turned on, a reset operation of removing electric charge of the floating diffusion node FD, and the photodiode connected to the floating diffusion node FD may be executed. When the electric charge of the floating diffusion node FD is removed, the select transistor SX may be turned on, and a reset voltage may be output to the column line COL.

After the reset operation, an exposure time period in which at least one of the photodiodes PD1-PD4 generates an electric charge in response to light may start. After the exposure time period is elapsed, the electric charge of at least one of the transfer transistors TX1 to TX4 may be transferred to the floating diffusion node FD by turning on at least one of the transfer transistors TX1 to TX4 while the reset transistor RX is turned off. As the select transistor SX is turned on, a signal voltage may be output to the column line COL.

The column line COL may be electrically connected to one of the input terminals of an amplifier included in the sampler. The other of the input terminals of the amplifier may receive the ramp voltage through a ramp buffer. The amplifier may compare the reset voltage with the ramp voltage and may compare the signal voltage with the ramp voltage. An output terminal of the amplifier may be connected to a counter, and for example, the counter may generate reset data by counting the time period until the magnitude relationship between the reset voltage and the ramp voltage is reversed, and may generate signal data by counting the time period until the magnitude relationship between the signal voltage and the ramp voltage is reversed. In an example embodiment, by computing a difference between the reset data and the signal data, a digital pixel signal corresponding to the electric charge generated by the photodiodes PD1-PD4 may be generated.

As illustrated in FIG. 3, by implementing the pixel PX such that two or more photodiodes PD1-PD4 share one pixel circuit, resolution of the image sensor may be effectively increased. In example embodiments, the number of photodiodes sharing one pixel circuit may be varied. For example, only one photodiode may be connected to the floating diffusion node FD, or a plurality of photodiodes, the number of which is less than or more than four, may be connected to the floating diffusion node FD.

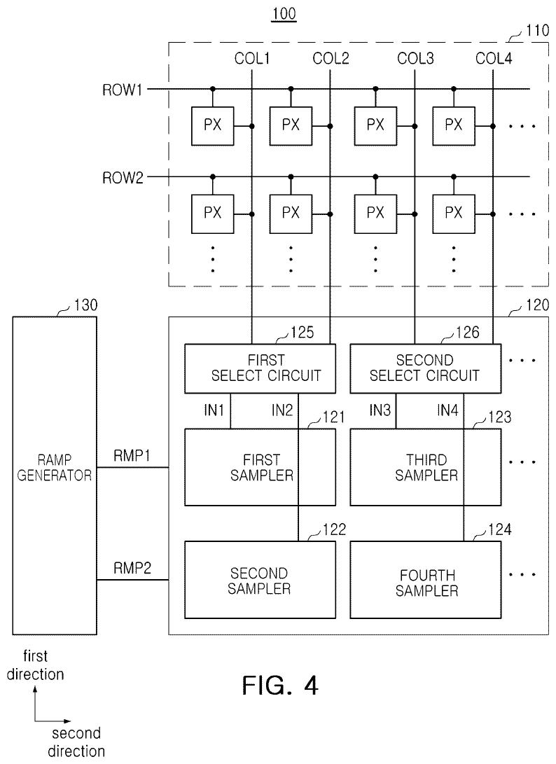

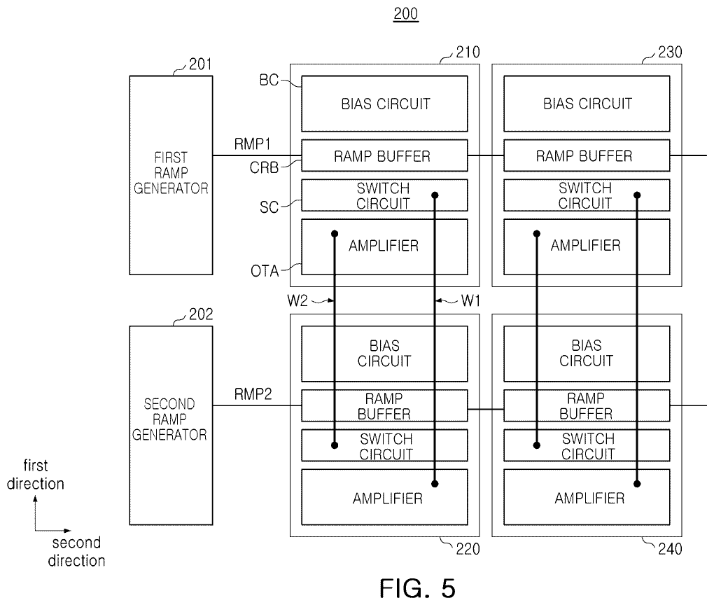

FIGS. 4 and 5 are diagram illustrating a structure of an image sensor according to an example embodiment.

Referring to FIG. 4, an image sensor 100 according to an example embodiment may include a pixel array 110, a readout circuit 120, and a ramp generator 130. The pixel array 110 may include a plurality of pixels PX arranged in a first direction corresponding to the vertical direction in FIG. 4 and a second direction corresponding to the horizontal direction in FIG. 4. The plurality of pixels PX may be connected to a plurality of row lines ROW1 and ROW2 and a plurality of column lines COL1 to COL4.

The readout circuit 120 may be connected to the plurality of pixels PX through the plurality of column lines COL1 to COL4 and may be connected to a ramp generator 130 through a first ramp line RMP1 and a second ramp line RMP2. The readout circuit 120 may include a plurality of samplers 121 to 124 configured to read a reset voltage and a signal voltage from a pixel PX selected from among the plurality of pixels PX.

In the readout circuit 120, a plurality of samplers 121 to 124 may be arranged in the first direction and the second direction. In the example embodiment illustrated in FIG. 4, the samplers 121 and 123 of the first group and the samplers 122 and 124 of the second group may be disposed adjacently to each other in the first direction. As illustrated in FIG. 4, by arranging the plurality of samplers 121 to 124 in the first direction and the second direction, the plurality of samplers 121 to 124 may be effectively disposed even in a structure in which an area of each of the plurality of pixels PX decreases.

The plurality of samplers 121 to 124 may be connected to the plurality of column lines COL1 to COL4 through select circuits 125 and 126. In the example embodiment illustrated in FIG. 4, a pair of samplers may be connected to a pair of column lines through a select circuit. For example, the first sampler 121 and the second sampler 122 may be connected to the first column line COL1 and the second column line COL2 through the first select circuit 125, and the third sampler 123 and the fourth sampler 124 may be connected to the third column line COL3 and the fourth column line COL4 through the second select circuit 126.

The input lines IN1 to IN4 of the plurality of samplers 121 to 124 may be connected to and disconnected from the plurality of column lines COL1 to COL4 and may operate by the select circuits 125 and 126 depending on an operation mode of the image sensor 100. For example, the first input line IN1 of the first sampler 121 may be connected to one of the first column line COL1 and the second column line COL2 through the first select circuit 125.

The plurality of samplers 121 to 124 may receive the first ramp voltage from the ramp generator 130 through the first ramp line RMP1, and may receive the second ramp voltage from the ramp generator 130 through the second ramp line RMP2. The ramp voltage received by each of the plurality of samplers 121 to 124 may vary depending on the operation mode of the image sensor 100. For example, when the image sensor 100 operates in the first mode, the plurality of samplers 121 to 124 may receive the first ramp voltage. When the image sensor 100 operates in a second mode different from the first mode, the samplers of a portion of the plurality of samplers 121 to 124 may receive the first ramp voltage, and the other samplers may receive the second ramp voltage.

FIG. 5 may be a diagram illustrating a structure of each of the plurality of samplers included in the readout circuit. Referring to FIG. 5, the image sensor 200 may include a plurality of samplers 210 to 240, and each of the plurality of samplers 210 to 240 may include a bias circuit BC, a ramp buffer CRB, a switch circuit SC, and an amplifier OTA. The plurality of samplers 210 to 240 may be connected to a plurality of column lines as described above with reference to FIG. 4, and may be arranged in the first direction and the second direction.

The bias circuit BC may be configured to supply a bias current to the plurality of column lines. The ramp buffer CRB may be connected to the first ramp generator 201 through the first ramp line RMP1, or may be connected to the second ramp generator 202 through the second ramp line RMP2. The ramp buffer CRB may buffer a ramp voltage received through the first ramp line RMP1 or the second ramp line RMP2 and may transfer the voltage to the switch circuit SC.

The switch circuit SC may transfer the ramp voltage output by the ramp buffer CRB to one of the input terminals of the amplifier OTA. For example, the amplifier OTA may be configured as a computational transconductance amplifier, and one of the input terminals of the amplifier OTA may be electrically connected to the column line, and the other may be electrically connected to the ramp buffer CRB through the switch circuit SC.

In the example embodiment illustrated in FIG. 5, among a plurality of samplers 210 to 240, the samplers 210 and 230 of the first group may be disposed in parallel with the first ramp generator 201, and the samplers 220 and 240 of the second group may be disposed in parallel with the second ramp generator 202. Accordingly, the ramp buffer CRB included in each of the samplers 210 and 230 of the first group may be connected to the first ramp line RMP1, and the ramp buffer CRB included in each of the samplers 220 and 240 of the second group may be connected to the second ramp line RMP2.

However, depending on an operation mode of the image sensor 200, an amplifier OTA included in at least a portion of the plurality of samplers 210 to 240 may receive a ramp voltage from a ramp buffer CRB included in another sampler. For example, when the image sensor 200 operates in a first mode, an amplifier OTA included in the second sampler 220 may be electrically separated from the ramp buffer CRB of the second sampler 220 by the switch circuit SC of the second sampler 220. In this case, the second ramp generator 202 may be deactivated and only the first ramp generator 201 may be activated, and the amplifier OTA of the second sampler 220 may be electrically connected to the first ramp line RMP1 through the ramp buffer CRB and the switch circuit SC of the first sampler 210. Accordingly, an amplifier OTA included in each of the first sampler 210 and the second sampler 220 may be electrically connected to the first ramp line RMP1.

Also, depending on an operation mode of the image sensor 200, the amplifier OTA included in each of the plurality of samplers 210 to 240 may receive the ramp voltage from the ramp buffer CRB included in the same sampler. For example, when the image sensor 200 operates in a second mode different from the first mode, the amplifier OTA of the first sampler 210 may be connected to the ramp buffer CRB of the first sampler 210 through the switch circuit SC of the first sampler 210, and the amplifier OTA of the second sampler 220 may be connected to the ramp buffer CRB of the second sampler 220 through the switch circuit SC of the second sampler 220. Accordingly, the amplifier OTA of the first sampler 210 may be connected to the first ramp line RMP1, and the amplifier OTA of the second sampler 220 may be connected to the second ramp line RMP2.

Referring to the example embodiments, when the image sensor 200 operates in the first mode, the amplifiers OTA of the samplers 220 and 240 of a second group may be connected to the first ramp line RMP1 through the ramp buffer CRBs of the samplers 210 and 230 of a first group, respectively. Accordingly, the second ramp generator 202, and the ramp buffer CRBs included in each of the samplers 220 and 240 of the second group may be deactivated, thereby reducing the power consumed by the image sensor 200.

When the image sensor 200 operates in the second mode, the samplers 210 and 230 of the first group may be connected to the first ramp line RMP1, and the samplers 220 and 240 of the second group may be connected to the second ramp line RMP2. The first ramp voltage output to the first ramp line RMP1 and the second ramp voltage output to the second ramp line RMP2 may have different properties. For example, slopes of the first ramp voltage and the second ramp voltage may be different from each other, and the first sampler 210 and the second sampler 220 may be commonly connected to one column line. Due to a difference in slopes of the first ramp voltage and the second ramp voltage, the first sampler 210 may read a signal output by one pixel with a first analog gain, and the second sampler 220 may read the same signal output by the same pixel with a second analog gain, different from the first analog gain. Each of the first sampler 210 and the second sampler 220 may read a signal output by one pixel connected to one column line with different analog gains. Accordingly, in the second mode, the dynamic range of the image sensor 200 may be improved.

To implement the above operation, a first wiring W1 and a second wiring W2, connecting the samplers adjacently to each other in the first direction, may be provided. Referring to FIG. 5, the first wiring W1 may connect the ramp buffer CRB of each of the samplers 210 and 230 of the first group to the amplifier OTA of each of the samplers 220 and 240 of the second group. For example, the first wiring W1 may connect an output terminal of the ramp buffer CRB included in the first sampler 210 to one of input terminals of the amplifier OTA included in the second sampler 220.

The second wiring W2 may connect the ramp buffer CRB of each of the samplers 220 and 240 of the second group to the amplifier OTA of each of the samplers 210 and 230 of the first group. For example, the second wiring W2 may connect the output terminal of the ramp buffer CRB included in the second sampler 220 to one of the input terminals of the amplifier OTA included in the first sampler 210.

As illustrated in FIG. 5, when the bias circuit BC, the ramp buffer CRB, the switch circuit SC and the amplifier OTA are disposed in the same structure in the samplers 210 and 230 of the first group and the samplers 220 and 240 of the second group, adjacently to each other in the first direction, the first wiring W1 and the second wiring W2 may have different lengths. For example, the first wiring W1 may be longer than the second wiring W2. When the structure in which the bias circuit BC, the ramp buffer CRB, the switch circuit SC and the amplifier OTA are disposed in the samplers 210 and 230 of the first group is different from the structure in which the bias circuit BC, the ramp buffer CRB, the switch circuit SC and the amplifier OTA are disposed are different in the samplers 220 and 240 of the second group, the length of the first wiring W1 and the length of the second wiring W2 may be substantially the same. In an embodiment, FIGS. 4 and 5 represents the physical arrangement of constituent elements of an image sensor. For example, the column lines COL1 to COL4 may extend in a first direction, and are spaced apart from each other in a second direction different from the first direction. The sampler 210 includes a first ramp buffer disposed in a first circuit region and connected to the first ramp generator, a first amplifier disposed in a second circuit region and configured to compare one of the first ramp voltage and the second ramp voltage with a voltage of a column line among the plurality of column lines. The first circuit region and the second circuit region are arranged in the first direction. The sampler 220 includes a second ramp buffer disposed in a third circuit region and connected to the second ramp generator, and a second amplifier disposed in a fourth circuit region and configured to compare one of the first ramp voltage and the second ramp voltage with a voltage of a column line among the plurality of column lines. The third circuit region and the fourth circuit region are arranged in the first direction.

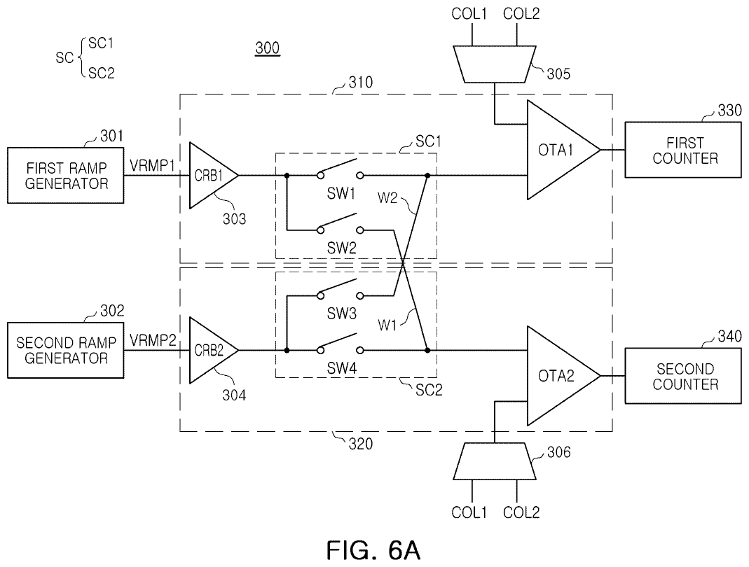

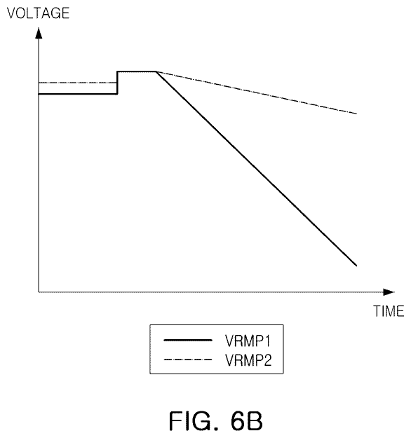

FIGS. 6A and 6B are diagrams illustrating an operation of an image sensor according to an example embodiment.

Referring to FIG. 6A, an image sensor 300 according to an example embodiment may include a first ramp generator 301, a second ramp generator 302, a first ramp buffer 303, a second ramp buffer 304, a switch circuit SC, a first amplifier OTA1, a second amplifier OTA2, a first counter 330, and a second counter 340.

The first ramp generator 301 may output a first ramp voltage VRMP1 to the first ramp buffer 303, and the second ramp generator 302 may output a second ramp voltage VRMP2 having properties different from the first ramp voltage VRMP1 to the second ramp buffer 304. In example embodiments, the first ramp voltage VRMP1 and the second ramp voltage VRMP2 may have different slopes.

The switch circuit SC may include a plurality of switches SW1-SW4. In the example embodiment illustrated in FIG. 6A, the first switch SW1 may be connected between the first ramp buffer 303 and the first amplifier OTA1, the second switch SW2 may be connected between the first ramp buffer 303 and the second amplifier OTA2, the third switch SW3 may be connected between the second ramp buffer 304 and the first amplifier OTA1, and the fourth switch SW4 may be connected between the second ramp buffer 304 and the second amplifier OTA2. For example, the wiring connecting the second switch SW2 to the second amplifier OTA2 may be the first wiring W1 described above with reference to FIG. 5. Also, for example, the wiring connecting the third switch SW3 to the first amplifier OTA1 may be the second wiring W2 described above with reference to FIG. 5.

Each of the first amplifier OTA1 and the second amplifier OTA2 may have a pair of input terminals. One of input terminals of the first amplifier OTA1 may be connected to the first select circuit 305, and the other of input terminals of the first amplifier OTA1 may be connected to the switch circuit SC. One of the input terminals of the second amplifier OTA2 may be connected to the second select circuit 306, and the other of the input terminals of the second amplifier OTA2 may be connected to the switch circuit SC.

In an example embodiment, the first ramp buffer 303, the first switch SW1, the second switch SW2, and the first amplifier OTA1 may be included in a first sampler 310, and the second ramp buffer 304, the third switch SW3, the fourth switch SW4, and the second amplifier OTA2 may be included in a second sampler 320. However, components of the first sampler 310 and the second sampler 320 is not included as above, and other components such as a bias circuit may be further included.

Each of the first select circuit 305 and the second select circuit 306 may be connected to two or more column lines COL1 and COL2, and one of the two or more column lines COL1 and COL2 may be selected and connected to the first amplifier OTA1 and the second amplifier OTA2. Lines connected to the input terminals of each of the first amplifier OTA1 and the second amplifier OTA2 may be determined by the switch circuit SC, the first select circuit 305 and the second select circuit 306. Operation of the switch circuit SC, the first select circuit 305 and the second select circuit 306 may be determined depending on an operation mode of the image sensor 300.

FIG. 6B may be a diagram illustrating the first ramp voltage VRMP1 and the second ramp voltage VRMP2. Referring to FIG. 6B, each of the first ramp voltage VRMP1 and the second ramp voltage VRMP2 may gradually decrease over time after being initialized by an auto-zero operation. In example embodiments, each of the first ramp voltage VRMP1 and the second ramp voltage VRMP2 may gradually increase over time after being initialized.

In the example embodiment illustrated in FIG. 6B, a slope of the first ramp voltage VRMP1 may be greater than a slope of the second ramp voltage VRMP2. In other words, the first ramp voltage VRMP1 may decrease faster than the second ramp voltage VRMP2.

As described above with reference to FIG. 6A, one of the input terminals of each of the amplifiers OTA1 and OTA2 included in the image sensor 300 may be connected to one of the column lines COL1 and COL2, and the other input terminal may receive the first ramp voltage VRMP1 or the second ramp voltage VRMP2. For example, when the first amplifier OTA1 is connected to the first column line COL1, the first amplifier OTA1 may sequentially compare the reset voltage and the signal voltage output by the pixel connected to the first column line COL1 with one of the first ramp voltage VRMP1 and the second ramp voltage VRMP2.

When the slopes of the first ramp voltage VRMP1 and the second ramp voltage VRMP2 are different, an analog gain of the first amplifier OTA1 may be adjusted by selecting one of the first ramp voltage VRMP1 and the second ramp voltage VRMP2. For example, the analog gain of the first amplifier OTA1 receiving the first ramp voltage VRMP1 may be smaller than the analog gain of the first amplifier OTA1 receiving the second ramp voltage VRMP2.

As described above, based on the adjustment of the analog gain using the slope of the ramp voltages VRMP1 and VRMP2, the dynamic range of the image sensor 300 may be widened. For example, the first amplifier OTA1 and the second amplifier OTA2 may be commonly connected to the first column line COL1, and the first ramp voltage VRMP1 may be input to the first amplifier OTA1, and the second ramp voltage VRMP2 may be input to the second amplifier OTA2. Therefore, the first amplifier OTA1 may compare a voltage of the first column line COL1 with the first ramp voltage VRMP1, and the second amplifier OTA2 may compare the voltage of the first column line COL1 with the second ramp voltage VRMP2. In the operation condition described above, the first amplifier OTA1 may read the reset voltage and the signal voltage output by the pixel connected to the first column line COL1 with a relatively small analog gain, and the second amplifier OTA2 may read the reset voltage and the signal voltage output by the pixel connected to the first column line COL1 with a relatively large analog gain. By merging the signal read by the first amplifier OTA1 and the signal read by the second amplifier OTA2, a high dynamic range (HDR) operation of widening the dynamic range of the image sensor 300 may be implemented.

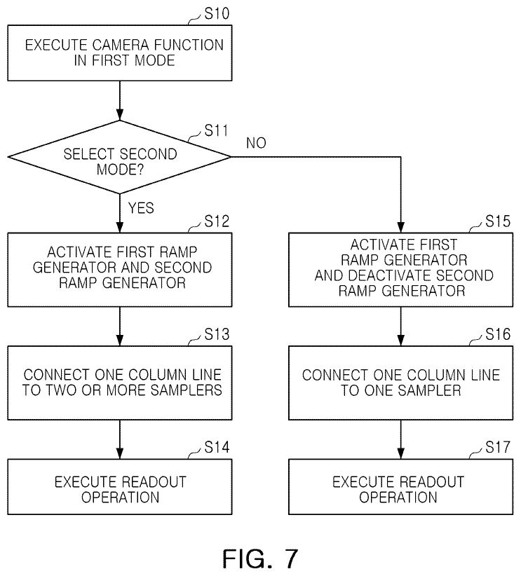

FIG. 7 is a flowchart illustrating operations of an image sensor according to an example embodiment.

Referring to FIG. 7, operation of an image sensor according to an example embodiment may start with executing a camera function by driving the image sensor in a first mode (S10). In an example embodiment, the first mode may be a default mode of a camera. After executing the camera function by driving the image sensor in the first mode, it may be determined whether a second mode is selected in the electronic device including the image sensor (S11).

In an example embodiment, the second mode may be an HDR mode in which the dynamic range of the image sensor is widened, and the electronic device including the image sensor may automatically switch the camera function from the first mode to the second mode based on the imaging environment. For example, when it is determined that a contrast ratio of the imaging region including a subject is greater than a predetermined reference contrast ratio, the electronic device may automatically switch the camera function from the first mode to the second mode. Alternatively, the camera function may be switched from the first mode to the second mode in response to an input from a user.

In operation S11, when the second mode of the camera function is selected, a first ramp generator and a second ramp generator may be activated in the image sensor (S12). As described above with reference to FIGS. 6A and 6B, the first ramp generator may output the first ramp voltage, the second ramp generator may output the second ramp voltage, and the first ramp voltage and the second ramp voltage may have different properties. For example, the first ramp voltage and the second ramp voltage may have different slopes.

In the second mode, in the readout operation executed after the exposure time period is elapsed, one column line may be connected to two or more samplers (S13). For example, when pixels arranged along a row line are selected, each of the column lines connected to a portion of the selected pixels may be commonly connected to the first sampler and the second sampler. As described above, in the image sensor in which the second mode is selected, the readout operation may be executed by connecting one column line to two or more samplers (S14).

The first sampler may receive the first ramp voltage from the first ramp generator, and the second sampler may receive the second ramp voltage from the second ramp generator. The first sampler may operate with a first analog gain, and the second sampler may operate with a second analog gain, which is different from the first analog gain, and the dynamic range of the pixel signal output by the pixel commonly connected to the first sampler and the second sampler through one column line may be widened. Accordingly, quality of the resulting image generated by the image sensor may be improved.

When the second mode is not selected in operation S11 and the first mode is maintained, the first ramp generator may be activated in the image sensor, and the second ramp generator may be deactivated (S15). The plurality of column lines connected to the plurality of pixels may be connected to the samplers one-to-one. For example, one column line may be connected to one sampler (S16). The samplers connected to the column lines may receive the first ramp voltage from the first ramp generator. As described above, in an image sensor in which the first mode is selected, a readout operation may be executed in a state in which one column line is connected to one sampler and a plurality of samplers are configured to input the first ramp voltage from the first ramp generator (S17). Accordingly, the readout operation may be executed in a state in which a plurality of second ramp buffers disposed in a path for transferring the second ramp voltage to the samplers are deactivated, and power consumption of the image sensor may be efficiently managed.

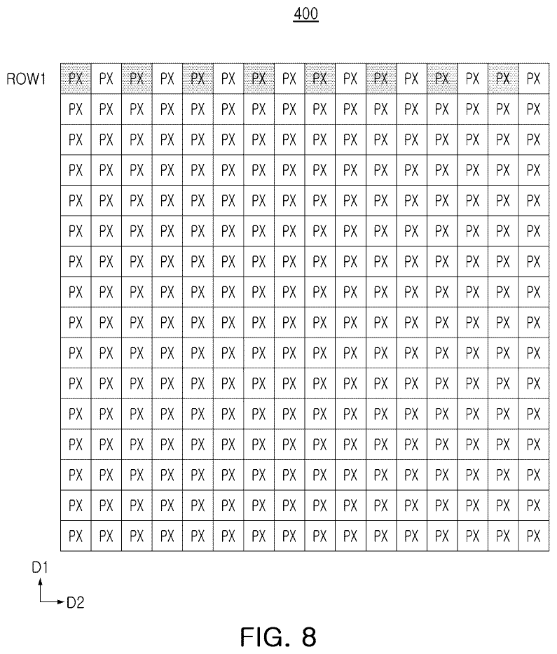

FIGS. 8, 9, 10, 11A, 11B, and 12 are diagrams illustrating operations of an image sensor according to an example embodiment.

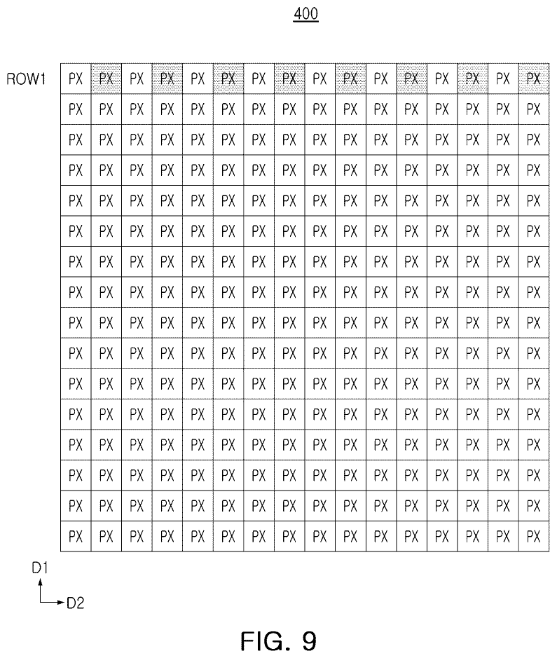

FIGS. 8, 9, 10, 11A, 11B, and 12 may be diagrams illustrating operations of an image sensor in a first mode, which is a default operation mode. Referring to FIGS. 8 and 9 illustrating a pixel array 400 included in the image sensor, a plurality of pixels PX may be arranged in a first direction D1 and a second direction D2. The first direction D1 may be a direction in which a plurality of column lines extend, and the second direction D2 may be a direction in which a plurality of row lines extend.

In the example embodiment described with reference to FIGS. 8, 9, 10, 11A, 11B, and 12 a portion of pixels PX arranged along one row line may be selected in sequence and a readout operation may be executed. Referring to FIG. 8, while the first row line ROW1 is selected, a readout operation for a portion of pixels PX placed in odd positions along the second direction D2, may be executed first. Thereafter, as illustrated in FIG. 9, a readout operation for the other pixels PX placed in even positions along the second direction D2 may be executed while the first row line ROW1 is still selected.

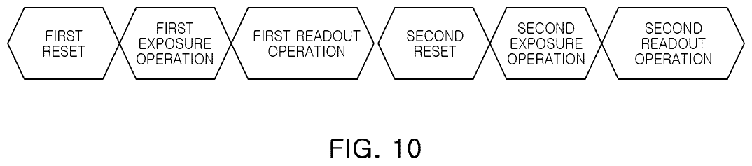

FIG. 10 may be a diagram illustrating a readout operation for pixels PX arranged along one row line over time. Referring to FIGS. 8, 9, and 10 together, by the first reset operation, electric charges of the photodiodes and floating diffusion nodes may be removed from each of the pixels PX arranged along the first row line ROW1. Thereafter, during a first exposure time period in which the first exposure operation is executed, electric charges may be generated by the photodiode in each of the pixels PX arranged along the first row line ROW1.

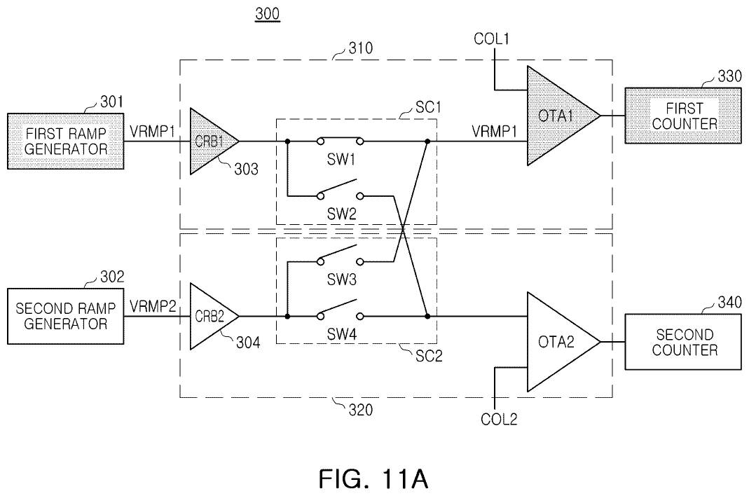

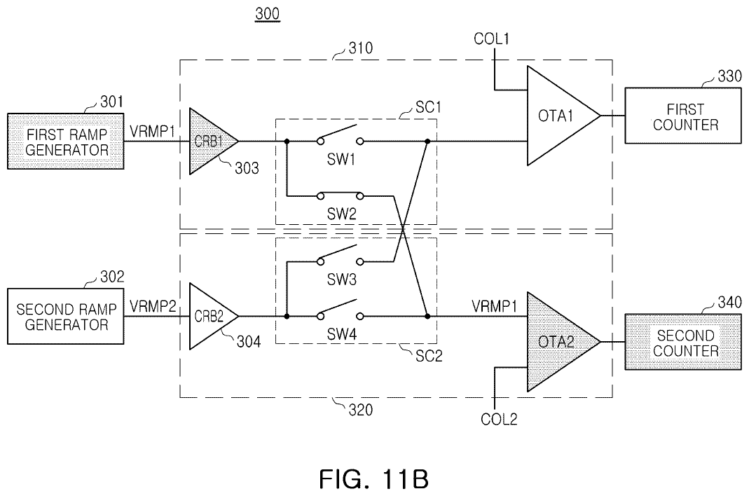

The first readout operation may be an operation of reading a reset voltage and a signal voltage from each of a portion of the pixels PX placed in odd positions along the first row line ROW1 as illustrated in FIG. 8. Referring to FIG. 11A, the first column line COL1 connected to the pixel PX disposed first in the second direction D2 may be connected to a first input terminal of the first amplifier OTA1. The second column line COL2 connected to the pixel PX disposed second in the second direction D2 may be connected to the first input terminal of the second amplifier OTA2.

While the first readout operation is executed, the first ramp generator 301 and the first ramp buffer 303 may be activated, the second ramp generator 302 and the second ramp buffer 304 may be deactivated, and the first switch SW1 in the switch circuit SC may be turned on. The other switches SW2, SW3, and SW4 may be turned off. The second input terminal of the first amplifier OTA1 may receive the first ramp voltage VRMP1 output by the first ramp generator 301 through the first switch SW1 and the first ramp buffer 303. While the first readout operation is executed, the ramp voltage may not be input to the second input terminal of the second amplifier OTA2, and accordingly, the second amplifier OTA2 may not operate, and the readout operation for the second column line COL2 may not be executed.

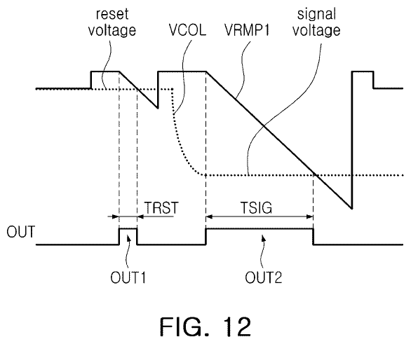

As illustrated in FIG. 12, the first counter 330 may output an output signal OUT including a first digital signal OUT1 and a second digital signal OUT2. The first counter 330 may output the first digital signal OUT1 by counting a reset time period TRST during which the reset voltage output to the first column line COL1 is less than the first ramp voltage VRMP1, and may output the second digital signal OUT2 by counting a signal time period TSIG during which the signal voltage output to the first column line COL1 is less than the first ramp voltage VRMP1. For example, by computing a difference between a length of the first digital signal OUT1 and a length of the second digital signal OUT2, a digital pixel signal for the pixel PX connected to the first column line COL1 may be generated. A voltage signal VCOL is a voltage of the first column line COL1, and includes the reset voltage before exposure and the signal voltage after exposure.

After the first readout operation is completed, the second reset operation may be executed, and the second reset operation may be similar to the first reset operation. For example, electric charge of the photodiode and the floating diffusion node may be removed from each of the pixels PX arranged along the first row line ROW1 by the second reset operation. Thereafter, during the second exposure time period in which the second exposure operation is executed, electric charge may be generated by the photodiode of each of the pixels PX arranged along the first row line ROW1.

In the second readout operation, the reset voltage and the signal voltage may be read from each of a portion of the pixels PX placed in even positions along the first row line ROW1 as illustrated in FIG. 9. Referring to FIG. 11B, the first column line COL1 connected to the pixel PX disposed first in the second direction D2 may be connected to the first input terminal of the first amplifier OTA1. The second column line COL2 connected to the pixel PX disposed second in the second direction D2 may be connected to the first input terminal of the second amplifier OTA2.

While the second readout operation is executed, the first ramp generator 301 and the first ramp buffer 303 may be activated, the second ramp generator 302 and the second ramp buffer 304 may be deactivated, and the second switch SW2 in the switch circuit SC may be turned on. The other switches SW1, SW3, and SW4 may be turned off. The second input terminal of the second amplifier OTA2 may receive the first ramp voltage VRMP1 output by the first ramp generator 301 through the second switch SW2 and the first ramp buffer 303. While the second readout operation is executed, both of the first ramp voltage VRMP1 and the second ramp voltage VRMP2 may not be input to the second input terminal of the first amplifier OTA1, and accordingly, the first amplifier OTA1 may not operate, and the readout operation for the first column line COL1 may not be executed.

The operation of the second counter 340 may be similar to the operation of the first counter 330 described above. The second counter 340 may output a first digital signal by counting a reset time period TRST during which the reset voltage output to the second column line COL2 is less than the first ramp voltage VRMP1, and may output a second digital signal by counting a time period during which the signal voltage TSIG output to the second column line COL2 is less than the first ramp voltage VRMP1. By computing a difference between a length of the first digital signal and a length of the second digital signal, a digital pixel signal for the pixel PX connected to the second column line COL2 may be generated.

In the example embodiment described with reference to FIGS. 8, 9, 10, 11A, 11B, and 12 an image sensor operating in the first mode may execute a readout operation for the pixels PX arranged along each row line by being divided into the first readout operation and the second readout operation. For example, a first readout operation of reading a reset voltage and a signal voltage from pixels PX placed in odd positions along a selected row line, and a second readout operation of reading a reset voltage and a signal voltage from pixels PX placed in even positions along a selected row line may be executed separately. Accordingly, the power consumption of the image sensor may be reduced.

Also, as described with reference to FIGS. 8, 9, 10, 11A, 11B, and 12, in the image sensor 300 operating in the first mode, only the first ramp generator 301 may be activated and the second ramp generator 302 may be deactivated. Accordingly, by eliminating the power consumption of the second ramp generator 302 and the second ramp buffer 304, the power consumption of the image sensor 300 may be effectively managed.

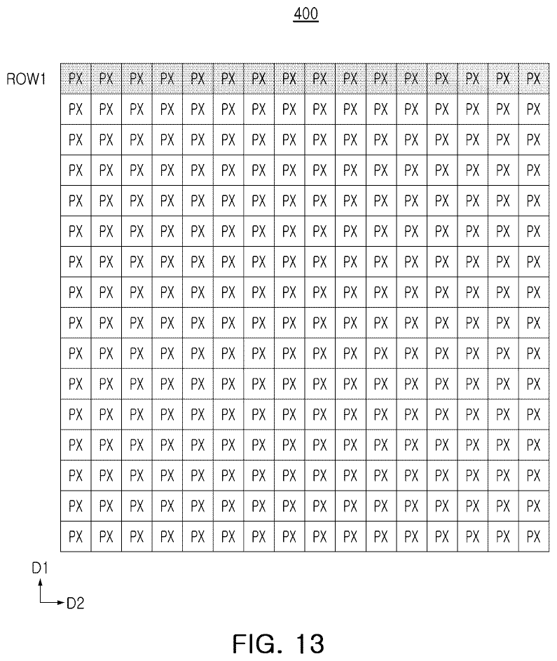

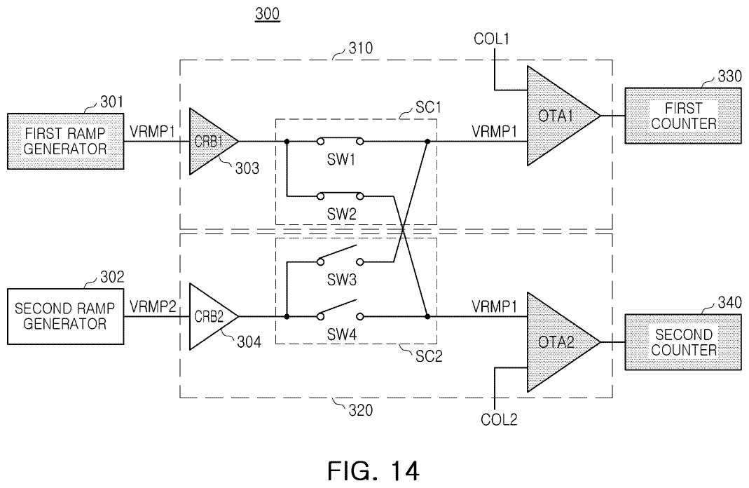

FIGS. 13 and 14 are diagrams illustrating operations of an image sensor according to an example embodiment.

In the example embodiment illustrated in FIGS. 13 and 14, an image sensor operating in the first mode may execute readout operations for pixels PX arranged along one row line collectively. Referring to FIG. 13, when the first row line ROW1 is selected, readout operations for the entirety of the pixels PX arranged along the first row line ROW1 in the second direction D2 may be executed simultaneously.

Referring to FIG. 14, the first column line COL1 connected to the pixel PX disposed first in the second direction D2 in the first row line ROW1 may be connected to the first input terminal of the first amplifier OTA1. The second column line COL2 connected to the pixel PX disposed second in the second direction D2 may be connected to the first input terminal of the second amplifier OTA2.

In the example embodiment described with reference to FIGS. 13 and 14, while a readout operation for the pixels PX arranged along a first row line ROW1 is executed, a first ramp generator 301 and a first ramp buffer 303 may be activated, and a second ramp generator 302 and a second ramp buffer 304 may be deactivated. Also, in the switch circuit SC, a first switch SW1 and a second switch SW2 may be turned on. The other switches SW3 and SW4 may be turned off. A second input terminal of a first amplifier OTA1 may receive a first ramp voltage VRMP1 through the first switch SW1 and the first ramp buffer 303, and a second input terminal of a second amplifier OTA2 may receive a first ramp voltage VRMP1 through the second switch SW2 and the first ramp buffer 303.

Accordingly, both the first amplifier OTA1 and the second amplifier OTA2 may operate, and a readout operation for a first column line COL1 and a readout operation for a second column line COL2 may be executed simultaneously. The first counter 330 may count the time period during which the reset voltage and the signal voltage output to the first column line COL1 are each less than the first ramp voltage VRMP1, and the second counter 340 may count the time period during which the reset voltage and the signal voltage output to the second column line COL2 are each less than the first ramp voltage VRMP1.

In the example embodiment described with reference to FIGS. 13 and 14, since the readout operation for the entirety of the pixels PX arranged along one row line is executed collectively, an operation speed of the image sensor 300, for example, a frame rate, may be improved. Also, since the second ramp generator 302 and a plurality of ramp buffers connected to the second ramp generator 302 are maintained in an deactivated state in the readout operation, the power consumption of the image sensor 300 may be effectively reduced.

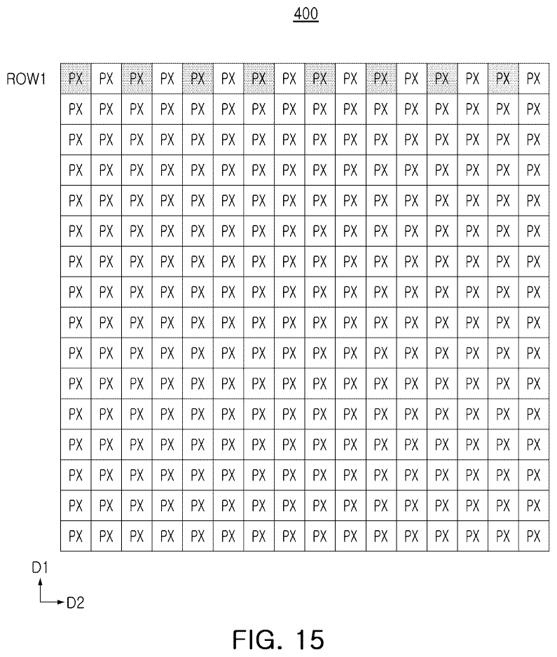

FIGS. 15, 16, 17, 18A, 18B, and 19 are diagrams illustrating operations of an image sensor according to an example embodiment.

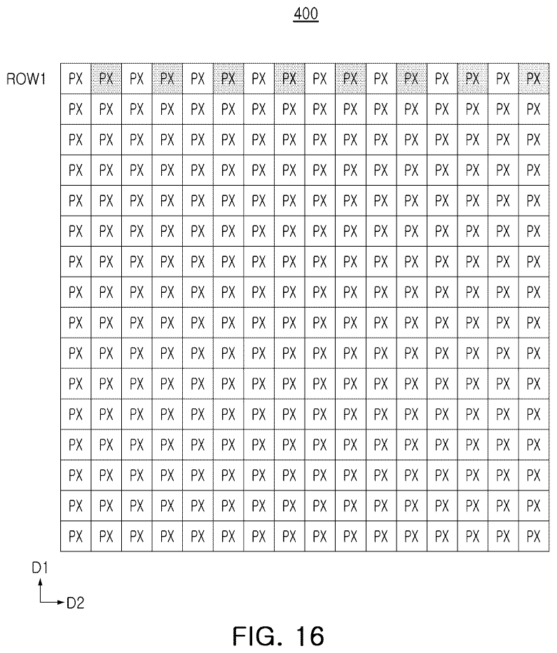

FIGS. 15, 16, 17, 18A, 18B, and 19 may be diagrams illustrating operations of the image sensor in the second mode for widening the dynamic range of the image sensor to improve quality of an image. Referring to FIGS. 15 and 16, a plurality of pixels PX in a pixel array 400 may be arranged in a first direction D1 and a second direction D2. The first direction D1 may be a direction in which a plurality of column lines extend, and the second direction D2 may be a direction in which a plurality of row lines extend.

In the example embodiment described with reference to FIGS. 15 to 19, a portion of pixels PX arranged along one row line may be selected in sequence and a readout operation may be executed. Referring to FIG. 15, while the first row line ROW1 is selected, a readout operation for a portion of pixels PX placed in odd positions along the second direction D2, may be first executed. Thereafter, as illustrated in FIG. 16, while the first row line ROW1 is still selected, a readout operation for the other pixels PX placed in even positions along the second direction D2, may be executed. However, in the second mode, each of the column lines connected to the pixels PX, which are targets of the readout operation, may be commonly connected to two or more samplers.

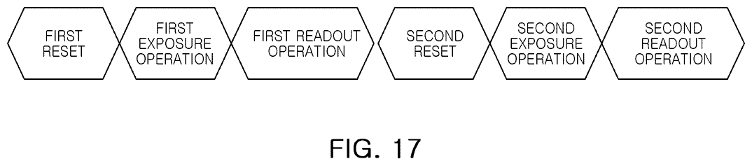

FIG. 17 may be a diagram illustrating a readout operation for pixels PX arranged along one row line over time. Referring to FIG. 17, electric charge of a photodiode and a floating diffusion node included in each of the pixels PX arranged along the selected row line may be removed by a first reset operation. Thereafter, during the first exposure time period in which the first exposure operation is executed, electric charge may be generated by a photodiode of each of the pixels PX arranged along the selected row line.

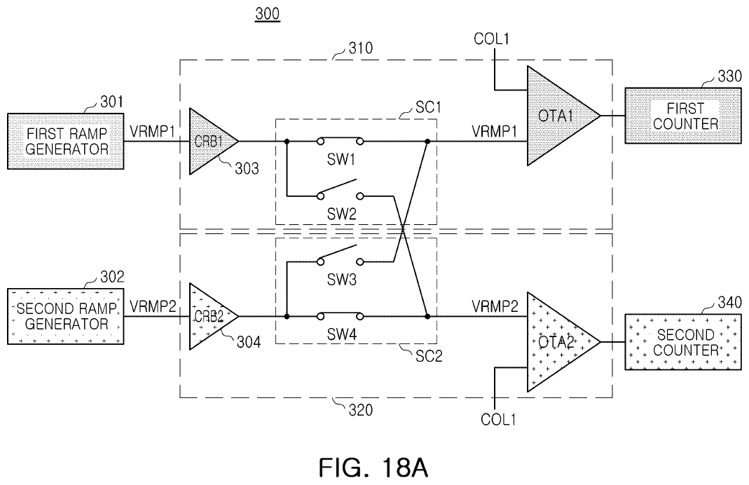

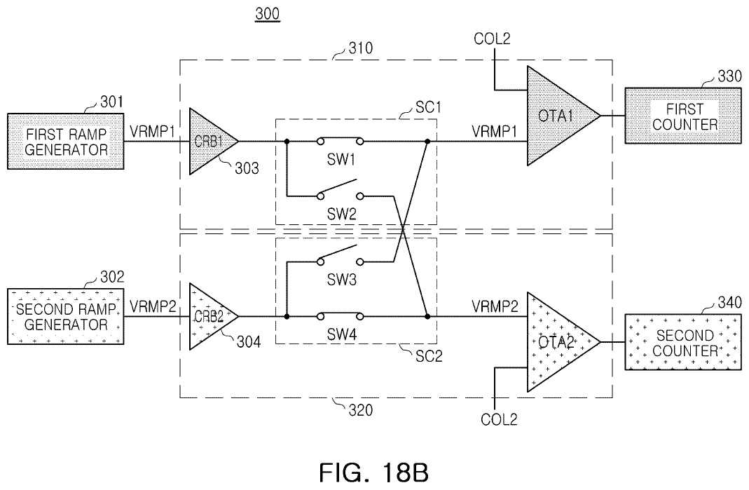

In the first readout operation, a reset voltage and a signal voltage may be read from each of the pixels PX of a portion disposed along the selected row line. Referring to FIG. 18A, the first column line COL1 connected to the pixel PX, which is a target of the first readout operation, may be connected to the first input terminal of the first amplifier OTA1 and the first input terminal of the second amplifier OTA2. In other words, the first column line COL1 connected to the pixel PX, which is a target of the first readout operation, may be commonly connected to the first amplifier OTA1 included in the first sampler and the second amplifier OTA2 included in the second sampler.

In the second mode, while the first readout operation is executed, both the first ramp generator 301 and the second ramp generator 302 may be activated, and the first ramp generator 301 may output the first ramp voltage VRMP1, and the second ramp generator 302 may output the second ramp voltage VRMP2. The first ramp voltage VRMP1 and the second ramp voltage VRMP2 may have different slopes, and both the first ramp buffer 303 and the second ramp buffer 304 may be activated.

In the switch circuit SC, the first switch SW1 and the fourth switch SW4 may be turned on. The other switches SW2 and SW3 may be turned off. Accordingly, a second input terminal of the first amplifier OTA1 may receive the first ramp voltage VRMP1 output by the first ramp generator 301 through the first switch SW1 and the first ramp buffer 303, and a second input terminal of the second amplifier OTA2 may receive the second ramp voltage VRMP2 output by the second ramp generator 302 through the fourth switch SW4 and the second ramp buffer 304.

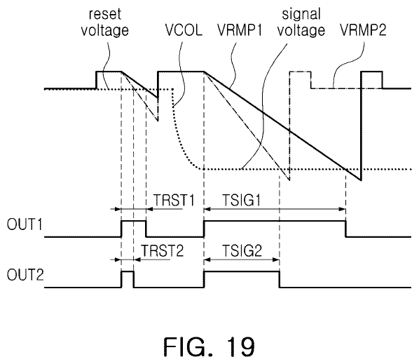

Referring to FIG. 19, the first counter 330 may count the first reset time period TRST1, in which the reset voltage output to the first column line COL1 is less than the first ramp voltage VRMP1, and the first signal time period TSIG1, in which the signal voltage output to the first column line COL1 is less than the first ramp voltage VRMP1. The second counter 340 may count the second reset time period TRST2, in which the reset voltage output to the first column line COL1 is less than the second ramp voltage VRMP2, and the second signal time period TSIG2, in which the signal voltage output to the first column line COL1 is less than the second ramp voltage VRMP2. In FIG. 19, a first output signal OUT1 is an output signal of the first counter 330, and a second output signal OUT2 is an output signal of the second counter 340. A voltage signal VCOL is a voltage of the first column line COL1, and includes the reset voltage of the first column line COL1 before exposure and the signal voltage of the first column line COL1 after exposure.

When the first readout operation ends, the second reset operation and the second exposure operation may be executed, and the second readout operation may be executed. In the second readout operation, the reset voltage and the signal voltage may be read from each of the other pixels PX disposed along the selected row line and not executing a readout operation in the first readout operation. Referring to FIG. 18B, the second column line COL2 connected to the pixel PX, which is a target of the second readout operation, may be connected to the first input terminal of the first amplifier OTA1 and the first input terminal of the second amplifier OTA2. In other words, the second column line COL2 connected to the pixel PX, which is a target of the second readout operation, may be commonly connected to the first amplifier OTA1 included in the first sampler 310 and the second amplifier OTA2 included in the second sampler 320.

Similarly to the first readout operation, while the second readout operation is executed, the first ramp generator 301, the second ramp generator 302, the first ramp buffer 303, and the second ramp buffer 304 may be activated. In the switch circuit SC, the first switch SW1 and the fourth switch SW4 may be turned on. Accordingly, the second input terminal of the first amplifier OTA1 may receive the first ramp voltage VRMP1 output by the first ramp generator 301 through the first switch SW1 and the first ramp buffer 303, and the second input terminal of the second amplifier OTA2 may receive the second ramp voltage VRMP2 output by the second ramp generator 302 through the fourth switch SW4 and the second ramp buffer 304. Operation of each of the first counter 330 and the second counter 340 may be similar to the example described above with reference to FIG. 19.

In the example embodiment described with reference to FIGS. 15 to 19, a slope of the first ramp voltage VRMP1 may be smaller than a slope of the second ramp voltage VRMP2. Accordingly, a first analog gain of the first amplifier OTA1 receiving the first ramp voltage VRMP1 may be larger than a second analog gain of the second amplifier OTA2 receiving the second ramp voltage VRMP2. As described above, when the first ramp voltage VRMP1 and the second ramp voltage VRMP2 have different slopes, the first amplifier OTA1 and the second amplifier OTA2 may operate with different analog gains, and the image sensor 300 may execute the first readout operation in a dual slope gain manner. By commonly inputting the reset voltage and the signal voltage output by one column line to the first amplifier OTA1 and the second amplifier OTA2 operating with different analog gains, the dynamic range of the image sensor 300 may be widened, thereby improving quality of the image.

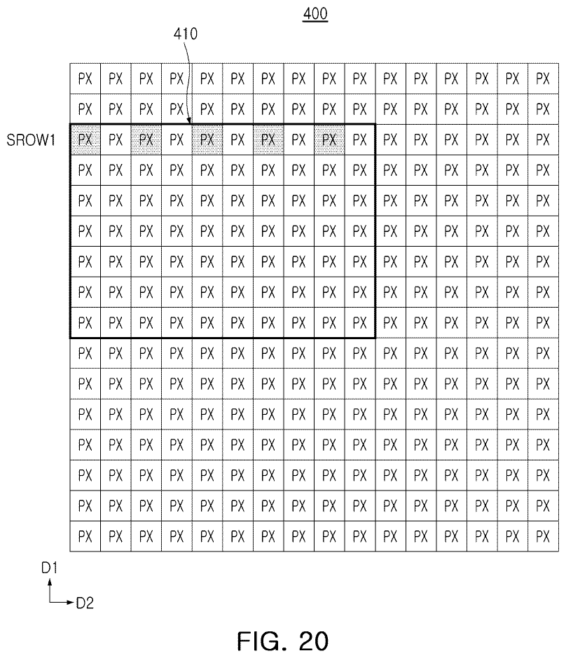

FIGS. 20, 21, 22A, 22B, 23, and 24 are diagrams illustrating operations of an image sensor according to an example embodiment.

FIGS. 20, 21, 22A, 22B, 23, and 24 may be diagrams illustrating operations of an image sensor in a third mode in which a specific region selected by a user is enlarged and displayed on a screen displayed on a display device of an electronic device including an image sensor. For example, in the third mode, the electronic device may execute a camera zoom function, and a portion of a user-selected region may be enlarged and displayed on the preview screen while the display device continues to show the overall preview.

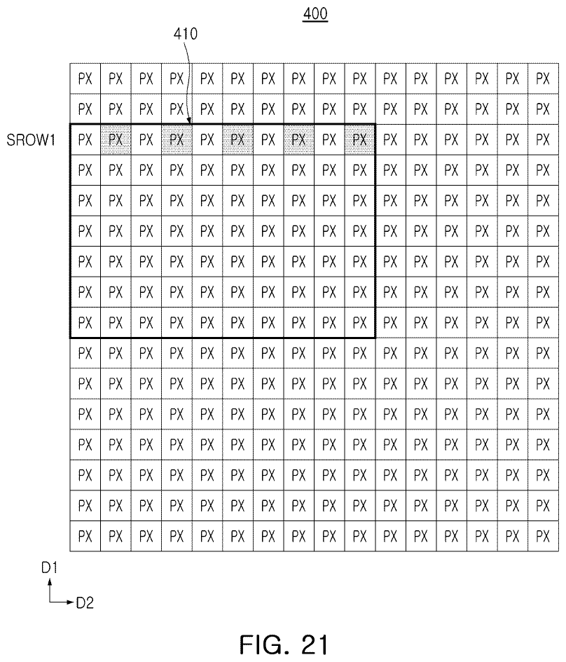

Referring to FIGS. 20 and 21, a select region 410 corresponding to a portion of a region selected by a user may be defined in a pixel array 400. When the select region 410 is determined, a portion of pixels PX arranged along each of the row lines included in the select region 410 may be sequentially selected and a readout operation may be executed. First, referring to FIG. 20, a first readout operation of reading a reset voltage and a signal voltage from a portion of pixels PX arranged along the first select row line SROW1 may be executed. Thereafter, as illustrated in FIG. 21, a second readout operation of reading a reset voltage and a signal voltage from the other pixels PX arranged along the first select row line SROW1 may be executed.

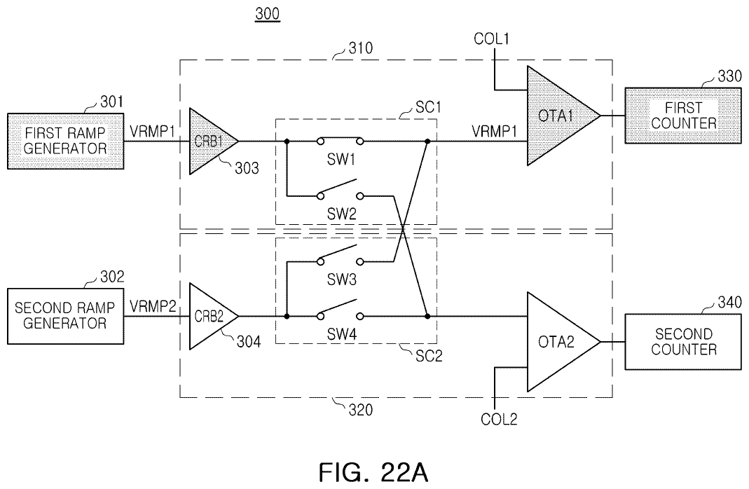

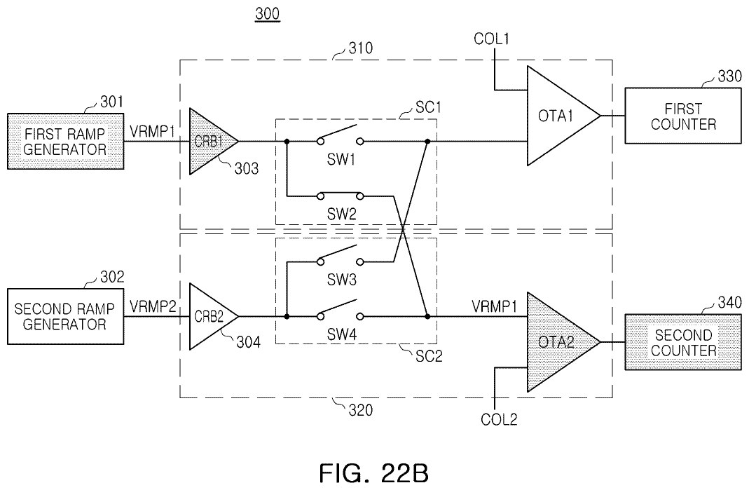

FIG. 22A may be a diagram illustrating the first readout operation, and FIG. 22B may be a diagram illustrating the second readout operation. Referring to FIG. 22A, the first column line COL1 connected to the first disposed pixel PX in the first select row line SROW1 may be connected to a first input terminal of the first amplifier OTA1. The second column line COL2 connected to the second disposed pixel PX in the second direction D2 may be connected to a first input terminal of the second amplifier OTA2.

While the first readout operation is executed, the first ramp generator 301 and the first ramp buffer 303 may be activated, the second ramp generator 302 and the second ramp buffer 304 may be deactivated, and the first switch SW1 in the switch circuit SC may be turned on. A second input terminal of the first amplifier OTA1 may receive the first ramp voltage VRMP1 output by the first ramp generator 301 through the first switch SW1 and the first ramp buffer 303. While the first readout operation is executed, the ramp voltage may not be input to the second input terminal of the second amplifier OTA2. Accordingly, the second amplifier OTA2 may not operate, and the readout operation for the second column line COL2 may not be executed. The first counter 330 may count the results of comparing each of the reset voltage and the signal voltage output by the first column line COL1 with the first ramp voltage VRMP1.

Referring to FIG. 22B, while the second readout operation is executed, the first ramp generator 301 and the first ramp buffer 303 may be activated, the second ramp generator 302 and the second ramp buffer 304 may be deactivated, and the second switch SW2 in the switch circuit SC may be turned on. The second input terminal of the second amplifier OTA2 may receive the first ramp voltage VRMP1 output by the first ramp generator 301 through the second switch SW2 and the first ramp buffer 303. While the second readout operation is executed, the ramp voltage may not be input to the second input terminal of the first amplifier OTA1, and accordingly, the first amplifier OTA1 may not operate, and the readout operation for the first column line COL1 may not be executed. The second counter 340 may count results of comparing each of the reset voltage and the signal voltage output to the second column line COL2 with the first ramp voltage VRMP1.

In the example embodiment described with reference to FIGS. 22A and 22B, an image sensor 300 operating in the third mode may execute a readout operation for pixels PX arranged along each row line included in a select region 410 to be enlarged by dividing the operation into the first readout operation and the second readout operation. For example, the first readout operation of reading a reset voltage and a signal voltage from pixels PX placed in odd positions along a selected row line, and the second readout operation for reading a reset voltage and a signal voltage from pixels PX placed in even positions along a selected row line may be executed separately. Accordingly, power consumption of the image sensor 300 may be efficiently managed.

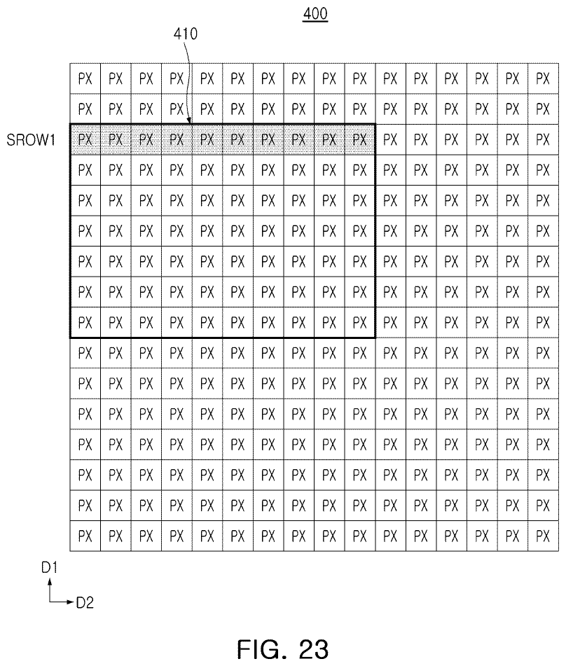

In example embodiments, the image sensor operating in the third mode may collectively execute readout operations for pixels PX arranged along each row line included in a select region 410 to be enlarged. Referring to FIG. 23, a readout operation for pixels PX arranged along each of the row lines included in the select region 410 may be executed collectively. For example, when the first select row line SROW1 is activated, a readout operation for reading a reset voltage and a signal voltage from each of the entirety of the pixels PX included in the select region 410 along the first select row line SROW1 may be executed.

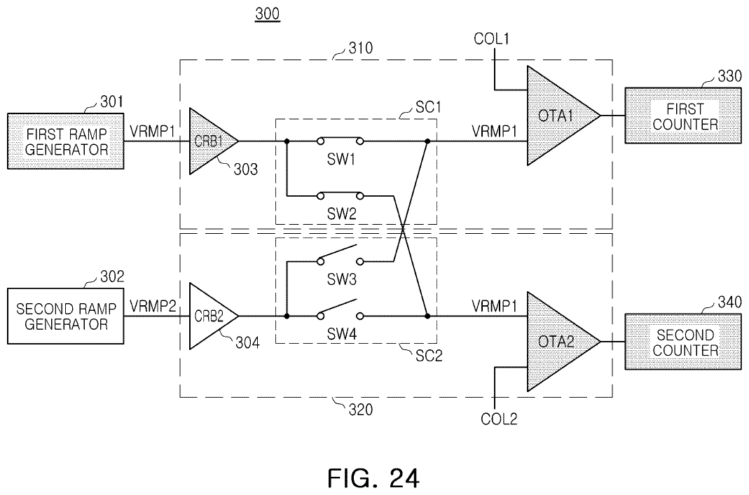

Referring to FIG. 24, the first column line COL1 may be connected to the first input terminal of the first amplifier OTA1, and the second column line COL2 may be connected to the first input terminal of the second amplifier OTA2. While the readout operation is executed, the first ramp generator 301 and the first ramp buffer 303 may be activated, the second ramp generator 302 and the second ramp buffer 304 may be deactivated, and the first switch SW1 and the second switch SW2 in the switch circuit SC may be turned on. The other switches SW3 and SW4 may be turned off.

The first ramp voltage VRMP1 may be input to the second input terminal of each of the first amplifier OTA1 and the second amplifier OTA2. Accordingly, while the readout operation is executed, the first counter 330 may count results of comparing the reset voltage and the signal voltage output to the first column line COL1 with the first ramp voltage VRMP1, and the second counter 340 may count results of comparing the reset voltage and the signal voltage output to the second column line COL2 with the second ramp voltage VRMP2. As described with reference to FIGS. 23 and 24, by executing the readout operation for the entirety of the pixels PX arranged along one select row line in the select region 410 collectively, an operation speed of the image sensor 300 may be improved.

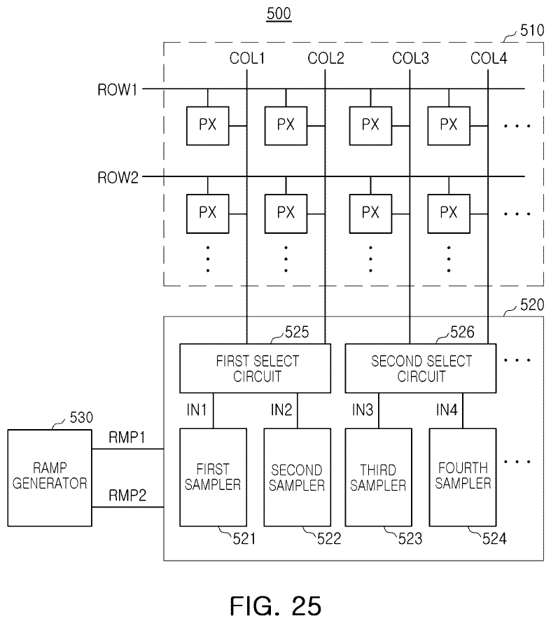

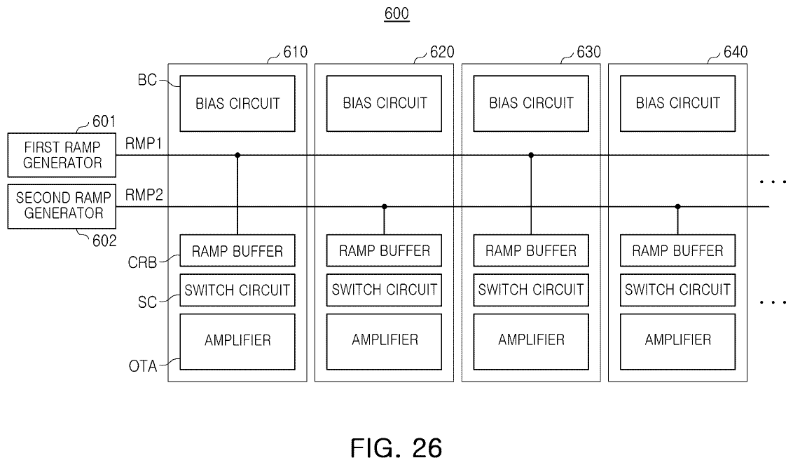

FIGS. 25 and 26 are diagrams illustrating a structure of an image sensor according to an example embodiment.

Referring to FIG. 25, an image sensor 500 according to an example embodiment may include a pixel array 510, a readout circuit 520, and a ramp generator 530. The pixel array 510 may include a plurality of pixels PX arranged in a first direction corresponding to a vertical direction and a second direction corresponding to a horizontal direction. The plurality of pixels PX may be connected to a plurality of row lines ROW1 and ROW2 and a plurality of column lines COL1 to COL4.

The readout circuit 520 may be connected to a plurality of pixels PX through a plurality of column lines COL1 to COL4 and may be connected to a ramp generator 530 through a first ramp line RMP1 and a second ramp line RMP2. The readout circuit 520 may include a plurality of samplers 521 to 524 configured to compare a reset voltage and a signal voltage output by a pixel PX selected from among a plurality of pixels PX with a ramp voltage.

Referring to FIG. 25, the plurality of samplers 521 to 524 included in the readout circuit 520 may be arranged in the second direction. In the example embodiment illustrated in FIG. 25, an area of each of the plurality of pixels PX may be relatively larger than in the example embodiment illustrated in FIG. 4. Accordingly, the plurality of samplers 521 to 524 may be arranged only in the second direction.

The plurality of samplers 521 to 524 may be connected to a plurality of column lines COL1 to COL4 through select circuits 525 and 526. In the example embodiment illustrated in FIG. 25, a pair of samplers may be selectively connected to a pair of column lines through a single select circuit. For example, the first sampler 521 and the second sampler 522 may be connected to the first column line COL1 and the second column line COL2 through the first select circuit 525, and the third sampler 523 and the fourth sampler 524 may be connected to the third column line COL3 and the fourth column line COL4 through the second select circuit 526.

The input lines IN1 to IN4 of the plurality of samplers 521 to 524 may be connected and disconnected from the plurality of column lines COL1 to COL4. The select circuits 525 and 526 may form connections between the column lines COL1 to COL4 and the input lines IN1 to IN4 depending on an operation mode of the image sensor 500. For example, the first input line IN1 of the first sampler 521 may be connected to one of the first column line COL1 and the second column line COL2 through the first select circuit 525. The second input line IN2 of the second sampler 522 may be connected to one of the first column line COL1 and the second column line COL2 through the first select circuit 525. Depending on the operation mode of the image sensor 500, the first input line IN1 and the second input line IN2 may be commonly connected to one of the first column line COL1 and the second column line COL2.

The plurality of samplers 521 to 524 may receive the first ramp voltage from the ramp generator 530 through the first ramp line RMP1 and may receive the second ramp voltage from the ramp generator 530 through the second ramp line RMP2. The ramp voltage received by each of the plurality of samplers 521 to 524 may vary depending on the operation mode of the image sensor 100. For example, when the image sensor 500 operates in the first mode, the plurality of samplers 521 to 524 may be electrically connected to the first ramp line RMP1 and may be electrically separated from the second ramp line RMP2.

When the image sensor 500 operates in a second mode different from the first mode, a portion of samplers of the plurality of samplers 521 to 524 may receive the first ramp voltage, and other samplers may receive the second ramp voltage. For example, the first input line IN1 and the second input line IN2 may be commonly connected to the first column line COL1, the first sampler 521 may be connected to the first ramp line RMP1, and the second sampler 522 may be connected to the second ramp line RMP2. By configuring the connection between the pixel array 510, the readout circuit 520, and the ramp generator 530 as described above, the voltage output by the pixel PX connected to the first column line COL1 may be read by the readout circuit 520 with a wide dynamic range.

FIG. 26 may be a diagram illustrating a structure of each of the plurality of samplers included in the readout circuit of FIG. 25. Referring to FIG. 26, the image sensor 600 may include a plurality of samplers 610 to 640, and each of the plurality of samplers 610 to 640 may include a bias circuit BC, a ramp buffer CRB, a switch circuit SC, and an amplifier OTA. The plurality of samplers 610 to 640 may be connected to a plurality of column lines through a select circuit as described above with reference to FIG. 25, and may be arranged in one direction.

The bias circuit BC may be configured to supply a bias current to the plurality of column lines. The ramp buffer CRB may be connected to the first ramp generator 601 through the first ramp line RMP1, or may be connected to the second ramp generator 602 through the second ramp line RMP2. The ramp buffer CRB may buffer the ramp voltage received through the first ramp line RMP1 or the second ramp line RMP2 and transfer the voltage to the switch circuit SC.

In the example embodiment illustrated in FIG. 26, the ramp buffer CRB included in each of odd samplers 610 and 630 may be connected to the first ramp line RMP1, and the ramp buffer CRB included in each of even samplers 620 and 640 may be connected to the second ramp line RMP2. However, the connection structure between the ramp buffer CRB and the ramp lines RMP1 and RMP2 may vary depending on an example embodiment. For example, the ramp buffer CRB included in the first sampler 610 and the fourth sampler 640 may be connected to the first ramp line RMP1, and the ramp buffer CRB included in the second sampler 620 and the third sampler 630 may be connected to the second ramp line RMP2.

The switch circuit SC may transfer the ramp voltage output by the ramp buffer CRB to one of the input terminals of the amplifier OTA. For example, the amplifier OTA may be configured as a computational transconductance amplifier. One of the input terminals of the amplifier OTA may be electrically connected to the column line, and the other may be electrically connected to the ramp buffer CRB through the switch circuit SC.

In the example embodiment illustrated in FIG. 26, the ramp buffer CRB connected to the amplifier OTA included in each of the plurality of samplers 610 to 640 may be determined depending on an operation mode of the image sensor 600. For example, the amplifier OTA included in each of the first sampler 610 and the second sampler 620 may be electrically connected to the first ramp line RMP1 through the switch circuit SC of the first sampler 610 and the ramp buffer CRB of the first sampler 610. The second ramp line RMP2 may be electrically separated from the amplifier OTA included in each of the first sampler 610 and the second sampler 620. The amplifier OTA included in a portion of the plurality of samplers 610 to 640 may be electrically connected to the switch circuit SC and the ramp buffer CRB included in the other sampler. In the operation mode as described above, the second ramp generator 602, and the ramp buffer CRB connected to the second ramp line RMP2 may be deactivated, and accordingly, the power consumption of the image sensor 600 may be efficiently reduced.

Also, depending on the operation mode of the image sensor 600, the amplifier OTA included in each of the plurality of samplers 610 to 640 may receive the ramp voltage from the ramp buffer CRB included in the same sampler. For example, the amplifier OTA of the first sampler 610 may be electrically connected to the first ramp line RMP1 through the switch circuit SC and the ramp buffer CRB of the first sampler 610, and the amplifier OTA of the second sampler 620 may be connected to the ramp buffer CRB of the second sampler 620 through the switch circuit SC of the second sampler 620. Accordingly, the amplifier OTA of the first sampler 610 may be connected to the first ramp line RMP1, and the amplifier OTA of the second sampler 620 may be connected to the second ramp line RMP2.

In the operation mode in which the amplifier OTA of the first sampler 610 is connected to the first ramp line RMP1, and the amplifier OTA of the second sampler 620 is connected to the second ramp line RMP2, the first ramp voltage may be output to the first ramp line RMP1, and the second ramp voltage may be output to the second ramp line RMP2. The first ramp voltage and the second ramp voltage may have the same properties, for example, the same slope, or may have different slopes.

When the first ramp voltage and the second ramp voltage have the same slope, a plurality of samplers 610 to 640 may be connected to a plurality of column lines one-to-one, and readout operations for pixels arranged along a selected row line in the pixel array may be executed collectively. When the first ramp voltage and the second ramp voltage have different slopes, by connecting two or more samplers to one column line in common, the readout operation may be executed with a wide dynamic range.

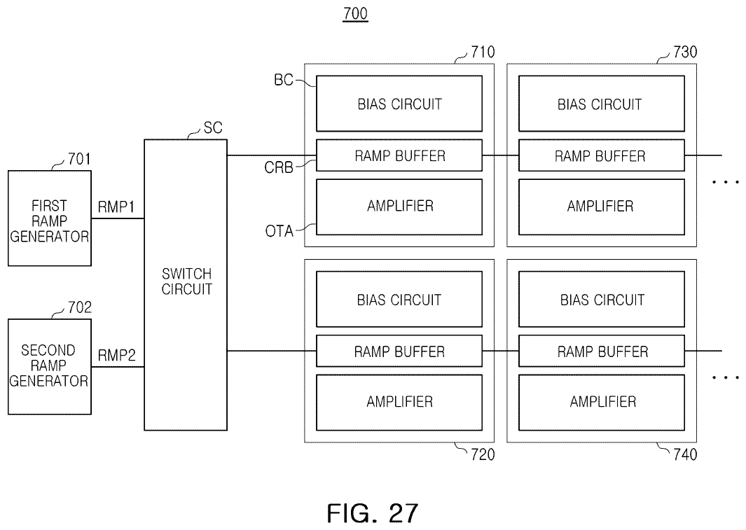

FIG. 27 is a diagram illustrating a structure of an image sensor according to an example embodiment.

Referring to FIG. 27, an image sensor 700 may include a plurality of samplers 710 to 740, and each of the plurality of samplers 710 to 740 may include a bias circuit BC, a ramp buffer CRB, and an amplifier OTA. The plurality of samplers 710 to 740 may be connected to a plurality of column lines and may be arranged in the first direction and the second direction.

In the example embodiment illustrated in FIG. 27, the switch circuit SC may be provided separately from the plurality of samplers 710 to 740. For example, the switch circuit SC may be connected to a first ramp line RMP1 in which a first ramp generator 701 outputs a first ramp voltage, and a second ramp line RMP2 in which a second ramp generator 702 outputs a second ramp voltage. The switch circuit SC may electrically connect at least one of the first ramp line RMP1 and the second ramp line RMP2 to the ramp buffer CRB of each of the plurality of samplers 710 to 740.

For example, the switch circuit SC may electrically connect one of the first ramp line RMP1 and the second ramp line RMP2 to the ramp buffer CRB of each of the plurality of samplers 710 to 740. The first ramp line RMP1 may be connected to the ramp buffer CRB of each of the plurality of samplers 710 to 740, and in this case, the second ramp generator 702 may be deactivated.

The switch circuit SC may connect the ramp buffer CRB of each of the samplers of a portion of the plurality of samplers 710 to 740 to the first ramp line RMP1, and may connect the ramp buffer CRB of each of the remaining samplers of the plurality of samplers 710 to 740 to the second ramp line RMP2. For example, in FIG. 27, the ramp buffer CRB of each of the odd samplers 710 and 730 disposed above in the first direction, which is the vertical direction, may be electrically connected to the first ramp line RMP1 through the switch circuit SC, and the ramp buffer CRB of each of the even samplers 720 and 740 disposed below in the first direction may be electrically connected to the second ramp line RMP2 through the switch circuit SC.

In the example embodiment illustrated in FIG. 27, by coordinating the connection between the ramp lines RMP1, RMP2 and the plurality of samplers 710 to 740 using one switch circuit SC, the area occupied by each of the plurality of samplers 710 to 740 may be reduced. Accordingly, integration density of the image sensor 700 may be improved. In example embodiments, the image sensor 700 may also be designed with a structure in which each of the plurality of samplers 710 to 740 does not individually include a ramp buffer. In this case, one ramp buffer CRB may be commonly connected to a portion of samplers 710 and 730, and another ramp buffer may be commonly connected to the remaining samplers 720 and 740.

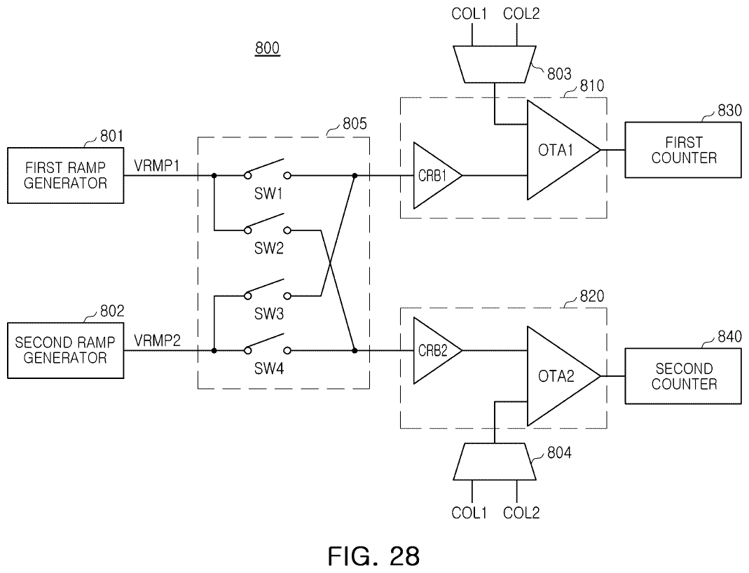

FIG. 28 is a diagram illustrating operations of an image sensor according to an example embodiment.

Referring to FIG. 28, an image sensor 800 according to an example embodiment may include a first ramp generator 801, a second ramp generator 802, a first select circuit 803, a second select circuit 804, a switch circuit 805, a first sampler 810, a second sampler 820, a first counter 830, and a second counter 840.

The first ramp generator 801 may output a first ramp voltage VRMP1, and the second ramp generator 802 may output a second ramp voltage VRMP2. In example embodiments, the first ramp voltage VRMP1 and the second ramp voltage VRMP2 may have the same slope or different slopes. The slope of each of the first ramp voltage VRMP1 and the second ramp voltage VRMP2 may be determined depending on an operation mode of the image sensor 800.

The switch circuit 805 may include a plurality of switches SW1-SW4. In the example embodiment illustrated in FIG. 28, the first switch SW1 may be connected between the first ramp generator 801 and the first ramp buffer CRB1 of the first sampler 810, and the second switch SW2 may be connected between the first ramp generator 801 and the second ramp buffer CRB2 of the second sampler 820. The third switch SW3 may be connected between the second ramp generator 802 and the first ramp buffer CRB1, and the fourth switch SW4 may be connected between the second ramp generator 802 and the second ramp buffer CRB2.

Each of the first amplifier OTA1 of the first sampler 810 and the second amplifier OTA2 of the second sampler 820 may have a pair of input terminals. One of the input terminals of the first amplifier OTA1 may be connected to the first select circuit 803, and the other of the input terminals of the first amplifier OTA1 may be connected to the first ramp buffer CRB1. Similarly, one of the input terminals of the second amplifier OTA2 may be connected to the second select circuit 804, and the other of the input terminals of the second amplifier OTA2 may be connected to the second ramp buffer CRB2.

In an example embodiment, the first ramp buffer CRB1 and the first amplifier OTA1 may be included in the first sampler 810, and the second ramp buffer CRB2 and the second amplifier OTA2 may be included in the second sampler 820. However, the components of the first sampler and the second sampler are not necessarily included as above, and other components such as a bias circuit may be further included. Each of the first select circuit 803 and the second select circuit 804 may be connected to two or more column lines COL1 and COL2, and one of the two or more column lines COL1 and COL2 may be selected and connected to the first amplifier OTA1 and the second amplifier OTA2.

In the example embodiment illustrated in FIG. 28, a single switch circuit 805 may be shared by a plurality of samplers 810 and 820. Accordingly, as compared to the structure in which each of the plurality of samplers 810 and 820 individually includes a switch circuit, the area occupied by each of the plurality of samplers 810 and 820 may be reduced, and integration density of the image sensor 800 may be improved.

According to the aforementioned example embodiments, the ramp generator outputs the first ramp voltage and the second ramp voltage, and depending on the operation mode, the ramp voltage received by each of the plurality of samplers may be configured differently. Accordingly, not only may the power consumption be effectively managed in various operation modes, but also the quality of the image generated by the image sensor may be improved.

While the example embodiments have been illustrated and described above, it will be configured as apparent to those skilled in the art that modifications and variations could be made without departing from the scope of the present disclosure as defined by the appended claims.

What is claimed is:

1. An image sensor, comprising:
a pixel array including a plurality of pixels arranged in a first direction and a second direction intersecting the first direction;
a plurality of samplers connected to the plurality of pixels through a plurality of column lines extending in the first direction; and
a ramp generator including:
a first ramp generator configured to output a first ramp voltage, and
a second ramp generator configured to output a second ramp voltage different from the first ramp voltage,
wherein the plurality of column lines include a first column line and a second column line adjacent to each other in the second direction,
wherein the plurality of samplers include a first sampler and a second sampler disposed adjacently to each other in the first direction,
wherein, in a first mode, the first sampler and the second sampler are electrically connected to the first ramp generator and electrically separated from the second ramp generator, and
wherein, in a second mode different from the first mode, the first sampler is electrically connected to the first ramp generator among the first ramp generator and the second ramp generator, and the second sampler is electrically connected to the second ramp generator among the first ramp generator and the second ramp generator.

2. The image sensor of claim 1,
wherein the first sampler includes:
a first ramp buffer disposed in a first circuit region and connected to the first ramp generator; and
a first amplifier disposed in a second circuit region and configured to compare one of the first ramp voltage and the second ramp voltage with a voltage of a column line among the plurality of column lines,
wherein the first circuit region and the second circuit region are arranged in the first direction,
wherein the second sampler includes:
a second ramp buffer disposed in a third circuit region and connected to the second ramp generator; and
a second amplifier disposed in a fourth circuit region and configured to compare one of the first ramp voltage and the second ramp voltage with a voltage of a column line among the plurality of column lines, and
wherein the third circuit region and the fourth circuit region are arranged in the first direction.

3. The image sensor of claim 2,
wherein the first sampler further includes:
a first switch circuit disposed in a fifth circuit region between the first circuit region and the second circuit region and configured to supply the first ramp voltage to one of the first amplifier of the first sampler and the second amplifier of the second sampler, and
wherein the second sampler further includes:
a second switch circuit disposed in a sixth circuit region between the third circuit region and the fourth circuit region and configured to supply the second ramp voltage to one of the first amplifier of the first sampler and the second amplifier of the second sampler.

4. The image sensor of claim 1,
wherein a first temporal slope of the first ramp voltage is different from a second temporal slope of the second ramp voltage.

5. The image sensor of claim 4,
wherein, in the second mode, the first sampler and the second sampler are connected to the first column line among the first column line and the second column line during a first time period, and the first sampler and the second sampler are connected to the second column line among the first column line and the second column line during a second time period after the first time period.

6. The image sensor of claim 5,
wherein during the first time period, the first sampler compares a voltage of the first column line with the first ramp voltage, and the second sampler compares the voltage of the first column line with the second ramp voltage, and
wherein, during the second time period, the first sampler compares a voltage of the second column line with the first ramp voltage, and the second sampler compares the voltage of the second column line with the second ramp voltage.

7. The image sensor of claim 1,
wherein, in the first mode, the first sampler is connected to the first column line among the first column line and the second column line and the second sampler is connected to the second column line among the first column line and the second column line, and
wherein, in the first mode, the first sampler compares a voltage of the first column line with the first ramp voltage during a first time period, and the second sampler compares a voltage of the second column line with the first ramp voltage during a second time period after the first time period.

8. The image sensor of claim 7,
wherein, in the first mode, the second ramp generator is deactivated.

9. The image sensor of claim 1,
wherein, in the first mode, the first sampler is connected to the first column line among the first column line and the second column line and the second sampler is connected to the second column line among the first column line and the second column line, and
wherein, in the first mode, the first sampler and the second sampler simultaneously compare the first ramp voltage with a voltage of the first column line and a voltage of the second column line, respectively.

10. An image sensor, comprising:
a pixel array including a plurality of pixels including a first pixel and a second pixel, the first pixel connected to a first column line and the second pixel connected to a second column line;
a ramp generator configured to output a ramp voltage; and
a readout circuit including a first sampler and a second sampler,
wherein each of the first sampler and the second sampler includes:
an amplifier configured to compare the ramp voltage with at least one of a voltage output by the first pixel and a voltage output by the second pixel,
a ramp buffer configured to receive the ramp voltage from the ramp generator and to transfer the ramp voltage to the amplifier, and
a switch circuit connecting the amplifier to the ramp buffer, and
wherein the switch circuit of the first sampler includes:
a first switch connecting the ramp buffer of the first sampler to the amplifier of the first sampler, and
a second switch connecting the ramp buffer of the first sampler to the amplifier of the second sampler.

11. The image sensor of claim 10,
wherein the switch circuit of the second sampler includes:
a third switch connecting the ramp buffer of the second sampler to the amplifier of the first sampler, and
a fourth switch connecting the ramp buffer of the second sampler to the amplifier of the second sampler.

12. The image sensor of claim 11,
wherein the ramp buffer of the first sampler receives a first ramp voltage from the ramp generator, and
wherein the ramp buffer of the second sampler receives a second ramp voltage from the ramp generator.

13. The image sensor of claim 12,
wherein a temporal slope of the first ramp voltage is different from a temporal slope of the second ramp voltage have, and
wherein the first switch and the fourth switch are turned on, and the second switch and the third switch are turned off.

14. The image sensor of claim 11,
wherein the first switch and the second switch are turned on and the third switch and the fourth switch are turned off.

15. The image sensor of claim 11,
wherein the first sampler and the second sampler are disposed adjacently to each other in a first direction in which the first column line and the second column line extend, and
wherein at least one first wiring electrically connecting the second switch to the amplifier of the second sampler extends in the first direction across a boundary between the first sampler and the second sampler.

16. The image sensor of claim 15,
wherein at least one second wiring electrically connecting the third switch to the amplifier of the first sampler extends in the first direction across the boundary between the first sampler and the second sampler.

17. The image sensor of claim 16,
wherein a length of the at least one first wiring is different from a length of the at least one second wiring in the first direction.

18. An operating method of an image sensor, the operating method comprising:
driving an image sensor in a first mode;
determining whether a second mode different from the first mode is selected;
connecting a plurality of column lines connected to a plurality of pixels included in the image sensor to a plurality of samplers, and inputting a first ramp voltage to the plurality of samplers, when the second mode is not selected and the first mode is maintained; and
connecting each of the plurality of column lines to two or more samplers among the plurality of samplers, inputting the first ramp voltage to one sampler of the two or more samplers, and inputting a second ramp voltage different from the first ramp voltage to another sampler of the two or more samplers, when the second mode is selected instead of the first mode.

19. The operating method of claim 18,
wherein, when the first mode is maintained, the plurality of column lines and the plurality of samplers are connected to each other one-to-one.

20. The operating method of claim 18, wherein the first ramp voltage and the second ramp voltage have different temporal slopes.
